(19) United States
(12) Patent Application Publication
(10) Pub. No.: US 2022/0269380 A1
(43) Pub. Date: Aug. 25, 2022

(54) METHOD AND SYSTEM FOR STRUCTURING, DISPLAYING, AND NAVIGATING INFORMATION

(71) Applicant: COLLECTION SCIENCE INC., Calgary (CA)

(72) Inventors: Peter TERTZAKIAN, Calgary (CA); Joshua Michael JOHNSGAARD, Calgary (CA); Spenser Evan JONES, Calgary (CA)

(21) Appl. No.: 17/618,225

(22) PCT Filed: Jun. 10, 2020
(86) PCT No.: PCT/CA2020/050793

§ 371 Date: Dec. 10, 2021

(30) Foreign Application Priority Data
Jun. 10, 2019 (CA) 3045835

(51) Int. Cl. G06F 3/0482; G06F 3/04845

(52) U.S. Cl. CPC G06F 3/0482; G06F 3/04845

(57) ABSTRACT

Computer-implemented methods and systems for structuring, displaying, and navigating information are disclosed. One embodiment may comprise: displaying a plurality of structured objects in a viewport of a display device, each structured object containing user-reviewable content; identifying an active structured object of the plurality of structured objects when a selector is located in a local area of the active structured object; transforming the local area of the active structured object into a first expanded local area at a fixed expansion rate; identifying a set of reactive structured objects from the plurality of structured objects when the selector is located in the first expanded local area of the active structured object; and transforming a local area of each reactive structured object into a second expanded local area at a dynamic expansion rate that varies relative to a location of the selector in the first expanded local area of the active structured object.

### TECHNICAL FIELD

This disclosure relates generally to computer-implemented methods and systems for structuring, displaying, and navigating information.

### BACKGROUND

There are various challenges to displaying a large amount of graphical content in a single viewing area for easy access and review by a user. The effectiveness of the communication may be limited by a size of the single viewing area, the volume of graphical content, and other information that may be accessible to the user. For example, if the graphical content or other information is displayed on a computer monitor with a browser, the larger the amount of content or information available, the more difficult it will be for the user to efficiently browse the content and information, for the content or information to be easily navigable, and for select content and information to be the focus of what is displayed to the user. Adjusting browser settings may help for smaller sets of information. But if the size of the single viewing area is fixed, or the volume of content and information is large, it can be challenging for a user to easily browse the content and information, to find content and information of interest, and to find related content and information.

In addition, challenges can arise in providing a more personalized experience for users with existing mechanisms for visualizing content.

Accordingly, there is a need for improved methods and systems for structuring, displaying, and navigating content and other information.

### SUMMARY OF THE INVENTION

Various methods and systems for structuring, displaying, and navigating information are described. In some aspects, computer-implemented methods and systems are provided for structuring and displaying via a graphical interface large collections of digital content using structured objects to organize the content in a structured and relational arrangement. In various embodiments the structured objects may be displayable objects referred to as vignettes. Some of the described methods and systems provide mechanisms for supporting visually navigating, via a display device, through the structured objects representing all or portion of one or more large collections of digital assets that are related by subject or thematically; and for supporting user review of digital assets contained in one or more select structured objects and other structured objects related to the one or more select structured objects.

According to one embodiment, there is provided a computer-implemented method comprising:
displaying a plurality of structured objects in a viewport of a display device, each structured object containing user-reviewable content;
identifying an active structured object of the plurality of structured objects when a selector is located in a local area of the active structured object;
transforming the local area of the active structured object into a first expanded local area at a fixed expansion rate;
identifying a set of reactive structured objects from the plurality of structured objects when the selector is located in the first expanded local area of the active structured object; and
transforming a local area of each reactive structured object into a second expanded local area at a dynamic expansion rate that varies relative to a location of the selector in the first expanded local area of the active structured object.

Identifying the active structured object may include tracking the location of the selector in the viewport.

The method may include determining when the selector engages the local area of the active structured object.

The fixed expansion rate may be the same for all of the plurality of structured objects.

Identifying the set of reactive structured objects may include applying a geometry-based rule set to the plurality of structured objects.

Applying the geometry-based rule set may include:
defining an identification area relative to the selector; and
identifying the set of reactive structured objects based on their proximity to the identification area.

The identification area may include a geometric shape centered on a selection point of the selector. The geometric shape may include a circle.

Identifying the set of reactive structured objects may include applying a plurality of rule sets to the plurality of structured objects.

The variable expansion rate may be calculated for each reactive structured object.

The method may further include: the first expanded local area of the active structured object defining a grid; and the variable expansion rate for each reactive structured object being continuously calculated for each reactive structured object based on the position of the selector in the grid.

Displaying the plurality of structured objects may include arranging the plurality of structured objects in a predetermined arrangement or shape in the viewport.

The method may further include: identifying a set of repeatable structured objects from the plurality of structured objects; and repeating each repeatable structured object in the predetermined arrangement or shape.

The predetermined arrangement or shape may include a spiral shape.

The plurality of structured objects may be overlapping in the spiral pattern to minimize a boundary area of the predetermined arrangement or shape.

The method may include moving the predetermined arrangement or shape in the viewport with the selector.

The method may further include applying a simulated friction force to a movement of the predetermined arrangement or shape in the viewport.

The method may further include randomly arranging the plurality of structured objects in the predetermined arrangement or shape.

The method may further include arranging the plurality of structured objects in the predetermined arrangement or shape based on data associated with each structured object.

Arranging the plurality of structured objects in the predetermined arrangement or shape may include:
identifying a set of publishable structured objects from the plurality of structured objects;
determining an initial order for the set of publishable structured objects; and
positioning the set of publishable structured objects in the predetermined arrangement or shape in the boundary area based on the initial order.

The method may include: generating dimensions for each publishable structured object; and sizing a boundary area of the predetermined arrangement or shape based on the dimensions.

Arranging the plurality of structured objects in the predetermined arrangement or shape may include:
identifying a set of related structured objects from the plurality of structured objects;
determining an initial order for the set of related structured objects; and
positioning the set of related structured objects in the predetermined arrangement or shape in the boundary area based on the initial order.

Identifying the set of related structured objects may include identifying the set of related structured objects associated with at least one category.

Determining the initial order may include:
identifying a set of repeatable structured objects from the set of related structured objects; and
repeating each repeatable structured object in the initial order based on data associated with each repeatable structured object.

The method may further include:
selecting a selected structured object of the plurality of structured objects with the selector; and
transforming the local area of the selected structured object into an expanded local area sized to occupy an enlarged portion of the viewport; and
displaying a interface configured, in response to user input, to change display between a first view of the selected structured object and a second view of the selected structured object.

The method may further include:
identifying an asset associated with the selected structured object;
identifying content associated with the asset; and
displaying the content on the second view of the selected structured object.

Displaying the content on the second view may include:
identifying a set of relevant structured objects from the plurality of structured objects; and
displaying links to each relevant structured object.

The method may further include:
associating each structured object of the plurality of structured objects with a time period; and
displaying the plurality of structured objects in the viewport based on the time periods.

The method may further include:
associating each structured object of the plurality of structured objects with a category; and
displaying the plurality of structured objects in the viewport based on the categories.

The method may further include:
identifying one or more stories associated with the active structured object; and
displaying a link to the one or more stories in a portion of the viewport.

The method may further include:
receiving search criteria; and
displaying the plurality of structured objects in the viewport based on the search criteria.

Displaying the plurality of structured objects in the viewport based on the search criteria may include:
identifying a set of relevant structured objects from the plurality of structured objects based on the search criteria;
identifying a set of non-relevant structured objects from the plurality of structured objects based on the search criteria; and
causing each relevant structured object to be emphasized or highlighted in the viewport.

Causing each relevant structured object to be emphasized or highlighted in the viewport may include:
displaying the set of relevant structured objects in a generally central portion of the viewport; and
displaying the set of non-relevant structured objects in a de-emphasized manner in the viewport.

According to another embodiment, there is provided a computer-implemented method comprising:
displaying a plurality of vignettes in a viewport of a display device;
identifying an active vignette of the plurality of vignettes when a selector is located in a local area of the active vignette;
transforming the local area of the active vignette into a first expanded local area at a fixed expansion rate;
identifying a set of reactive vignettes from the plurality of vignettes when the selector is located in the first expanded local area of the active vignette; and
transforming a local area of each reactive vignette into a second expanded local area at a dynamic expansion rate that varies relative to a location of the selector in the first expanded local area of the active vignette.

Other aspects of the present invention will become apparent to those ordinarily skilled in the art upon review of the following description of specific, illustrative aspects in conjunction with the accompanying figures.

### BRIEF DESCRIPTION OF THE DRAWINGS

The accompanying drawings illustrate exemplary aspects that, together with the written descriptions, serve to explain various embodiments according to this disclosure. With respect to the drawings:

FIG. 1 depicts a conceptual representation of a relational data structure comprising weighted associations between vignettes and stories.

FIG. 2A depicts an exemplary interface for accessing vignette data.

FIG. 2B depicts an exemplary interface for editing vignette data.

FIG. 2C depicts an exemplary interface for accessing tag data.

FIG. 2D depicts an exemplary interface for editing tag data.

FIG. 2E depicts an exemplary interface for accessing people data.

FIG. 2F depicts an exemplary interface for editing people data.

FIG. 2G depicts an exemplary interface for accessing story data.

FIG. 2H depicts an exemplary interface for editing story data.

FIG. 2I depicts an exemplary interface for accessing asset data.

FIG. 2J depicts an exemplary interface for editing asset data.

FIG. 3 depicts an exemplary graphical interface comprising a selector, a viewport, vignettes located in the viewport, and a plurality of interfaces.

FIG. 4 depicts the graphical interface of FIG. 3 in which a portion of the vignettes are in the viewport and the selector is outside of the viewport.

FIG. 5 depicts the graphical interface of FIG. 4 in which the selector is in the viewport within a local area of an active vignette; and local areas of a set of reactive vignettes have been modified responsive to the selector.

FIG. 6 depicts a conceptual representation of the graphical interface of FIG. 5, in which the content of each vignette has been replaced with a first hatching for the active vignette or a second hatching for the set of reactive vignettes.

FIG. 7 depicts the conceptual representation of FIG. 6 in which the selector is in an upper left portion of the expanded local area of the active vignette.

FIG. 8 depicts the conceptual representation of FIG. 6 in which the selector is in a lower left portion of the expanded local area of the active vignette.

FIG. 9 depicts the conceptual representation of FIG. 6 in which the selector is in a lower right portion of the expanded local area of the active vignette.

FIG. 10 depicts the conceptual representation of FIG. 6 in which the selector is in an upper right portion of the expanded local area of the active vignette.

FIG. 11 depicts the conceptual representation of FIG. 6 in which the selector is in an expanded local area of another active vignette and local areas of another set of reactive vignettes have been modified responsive to the selector.

FIG. 12 depicts the graphical interface of FIG. 3 in which the selector is engaged with a timeline interface.

FIG. 13 depicts the graphical interface of FIG. 3 in which the selector is engaged with a category interface.

FIG. 14 depicts the graphical interface of FIG. 6 after inputting search criteria into a search interface and conducting a search therewith.

FIG. 15 depicts the graphical interface of FIG. 6 with a featured vignette displayed in a local area sized to occupy a larger portion of the viewport.

FIG. 16 depicts an exemplary display of an asset associated with a featured vignette.

FIG. 17 depicts an exemplary display method for vignettes.

FIG. 18 depicts an exemplary ordering method for vignettes.

FIG. 19 depicts an exemplary navigation method for vignettes.

FIG. 20 depicts another exemplary display method for vignettes.

FIG. 21 depicts another exemplary display method for structured objects.

FIG. 22 depicts another exemplary ordering method for structured objects.

FIG. 23 depicts another exemplary navigation method for structured objects.

FIG. 24 depicts another exemplary display method for structured objects.

### DETAILED DESCRIPTION

Aspects of the present disclosure are not limited to the exemplary structural details and component arrangements described in this description and shown in the accompanying drawings. Many aspects of this disclosure may be applicable to other aspects and/or capable of being practiced or carried out in various variants of use, including the examples described herein.

Throughout the written descriptions, specific details are set forth to provide a more thorough understanding to persons of ordinary skill in the art. For convenience and ease of description, some well-known elements may be described conceptually to avoid unnecessarily obscuring the focus of this disclosure. In this regard, the written descriptions and accompanying drawings of the present disclosure should be interpreted as illustrative rather than restrictive, enabling rather than limiting.

Various aspects of the present disclosure generally relate to methods and systems for structuring, displaying, and navigating information. In various embodiments, computer-implemented methods and systems are provided for structuring and displaying via a graphical interface for large collections of digital content (e.g. digital assets) using structured objects to organize the content in a structured and relational arrangement. In various embodiments, the structured objects may comprise structured data (including, for example, user-reviewable content or links to such content) that may be displayed on the graphical interface in various ways. In various embodiments, the structured objects may be displayable objects referred to as vignettes. In various embodiments, each vignette may contain content related to a particular category, theme, topic, subject, and/or story. Aspects of some of the described methods and systems may provide mechanisms for supporting visually navigating, via a display device, through the structured objects representing all or a portion of one or more large collections of digital assets that are related by subject or thematically; and for supporting user review of digital assets contained in one or more select structured objects and other structured objects related to the one or more select structured objects.

The described aspects may utilize any known software technologies, such as program objects comprising blocks of codes executable to perform various functions; and any known hardware technologies, such as computing devices, network components, and storage mediums operable to execute the codes. Unless claimed, these examples are provided for convenience to illuminate and provide context for the methods and systems described herein and are not intended to limit the present disclosure.

As utilized herein, inclusive terms such as “comprises,” “comprising,” “includes,” “including,” and variations thereof, are intended to cover a non-exclusive inclusion, such that any method or system comprising a list of elements does not include only those elements, but also may include other elements not expressly listed and/or inherent thereto. Unless stated otherwise, the term “exemplary” is utilized in the sense of “example,” rather than “ideal.” The term “aspects” may refer to any part or feature of any method or system described herein, and may be used interchangeably with terms such as embodiments, examples, iterations, and the like. Terms of approximation may be utilized in this disclosure, including “approximately” and “generally.” Unless stated otherwise, approximately means in 10% of a stated number or outcome and generally means “in most cases” or “usually.”

Some aspects are described with reference to exemplary algorithms and related computational processes for manipulating data stored with in memory. An algorithm is generally a process or set of rules to be followed in calculations or other problem-solving operations, including as applicable to computer programs and computer-implemented methods and systems. The operations typically require or involve physical manipulations of physical representations of quantities, such as electrical or magnetic signals capable of being stored, transferred, combined, compared, and otherwise manipulated. For convenience, these signals may be described conceptually as bits, characters, elements, numbers, symbols, terms, values, or the like. Various exemplary algorithms and computational processes are described. As would be understood by persons of ordinary skill in the art, aspects of these examples may be combined with aspects of any known algorithms and/or processes to perform various functions described herein.

Hardware components that may be used comprise any applicable computing and/or networking elements, including any combination of mobile or stationary computers or computing devices operable to perform the described functions by generating and/or transmitting the aforementioned electrical or magnetic signals. For convenience and ease of description, any such hardware components may be depicted or described conceptually.

Functional terms such as “processing,” “computing,” “calculating,” “determining,” “displaying,” and the like, may refer to processes that are performable by any known hardware and/or software technologies. Terms, such as “process” or “processes” may be utilized interchangeably with other terms, such as “method(s)” or “operation(s)” or “procedure(s)” or “program(s)” or “step(s),” any of which may be similarly performable. For example, some processes or methods may be performed by a processing unit in communication with other storage, transmission, and/or display devices using any wired or wireless communication technology, in which the term “processing unit” means any number of processor(s), including any singular or plural processor(s) disposed local to or remote from one another. However configured, the processing unit may manipulate and transform data represented as physical (e.g., electronic) quantities in a memory into other data similarly represented as physical quantities in a memory.

In various embodiments, the term processing unit may comprise a special purpose computer constructed to perform the described processes; or a general-purpose computer operable with program objects to perform the processes. Each program object may comprise blocks of code stored in memory, such as a machine-readable storage medium, which may comprise any mechanism for storing or transmitting data and information in a form readable by a computer. A list of exemplary memory types may comprise: read only memory (“ROM”); random access memory (“RAM”); erasable programmable ROMs (EPROMs); electrically erasable programmable ROMs (EEPROMs); magnetic or optical cards or disks; flash memory devices; and/or any electrical, optical, acoustical or other form of propagated signals (e.g., carrier waves, infrared signals, digital signals, etc.).

Some processes are described with reference to conceptual drawings, such as flowcharts with boxes interconnected by arrows. The boxes may be combined, interconnected, and/or interchangeable to provide options for additional modifications according to this disclosure. In some aspects, the arrows may define an exemplary sequence for a program object. Although not required, the order of the sequence may be important. For example, the order of some sequences may be utilized to realize specific processing benefits with the program object, such as improving system performance.

The following terms have the following meanings in this disclosure:

A “vignette” is a type of structured object or item in a database. Each vignette may comprise images, text, audio, video and/or other forms of content. In some embodiments, each vignette may comprise a visual representation in the form of a description card with a first view or face comprising images and/or text or other content and a second view or face comprising additional content.

An “asset” is another type of structured object or item that may be stored in the database. Each asset may comprise additional content related to at least one vignette, including audio files, image files, video files, and the like. For example, the second view or face of some vignettes may comprise one or more assets.

A “story” is another type of structured object or item in the database that may be stored. Each story may comprise additional content related to a set of vignettes, including longer narratives of graphics and/or text related to the set. For example, activating one of the vignettes may cause a related story to be displayed.

A “tag” is a reference to one or more structured objects or items stored in the database. For example, each tag may comprise: one or more categories, themes or identifiers associated with a structured object or item stored the database, such as a vignette, asset, or story; and a weighting variable indicating a degree of relevancy between the applicable one or more categories, themes or identifiers and the structured object or item. In various embodiments, the one or more categories for each tag may comprise a parent category and one or more child categories. In some embodiments, an identifier associated with a structured object or item may comprise or be assigned an alphanumeric sequence (e.g. a keyword, phrase or the like).

A “relevancy score” indicates a degree of relevancy between any two structured objects or items in the relational database. For example, a relevancy score may be assigned or determined between two vignettes having a shared tag. In some embodiments, a relevancy score may be assigned or determined between each vignette and one or more stories.

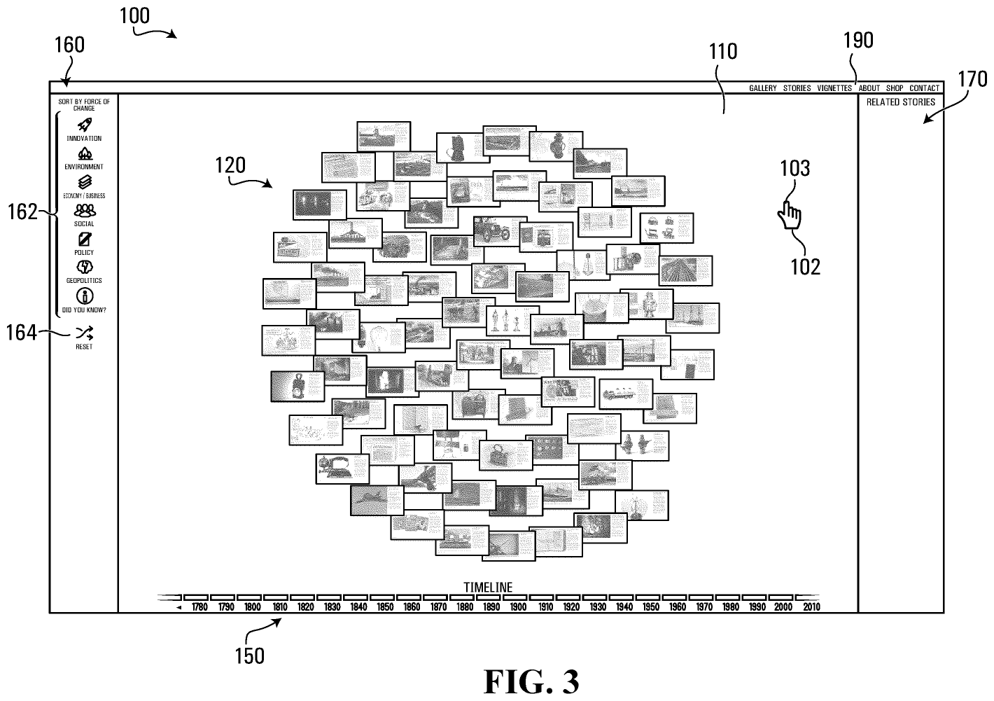

In various embodiments there is provided a multi-dependent network of tags with weighting variables, and an associated weighting system configured to arrange and re-arrange a plurality of vignettes (or other similar structured objects) in a viewport of a display based on the tags and their weighting variables. The vignettes may be arranged in a predetermined arrangement or shape in the viewport, such as the exemplary spiral shape shown in FIG. 3. For example, a set of vignettes may be located in a central portion of the predetermined arrangement or shape to focus the user on a subject; and the remaining vignettes may be located outwardly from the central portion to communicate peripheral details about the subject.

The predetermined arrangement or shape of the vignettes may be based on selection criteria. For example, in various embodiments, each vignette may be associated with a time or time period; and the selection criteria may include a selected time or time period, so that the vignettes happening at the selected time or time period are placed in the central portion, and the vignettes happening outside the selected time or time period are placed further away from the central portion. Any selection criteria may be utilized. Randomized selection criteria also may be utilized.

### Relational Database 1

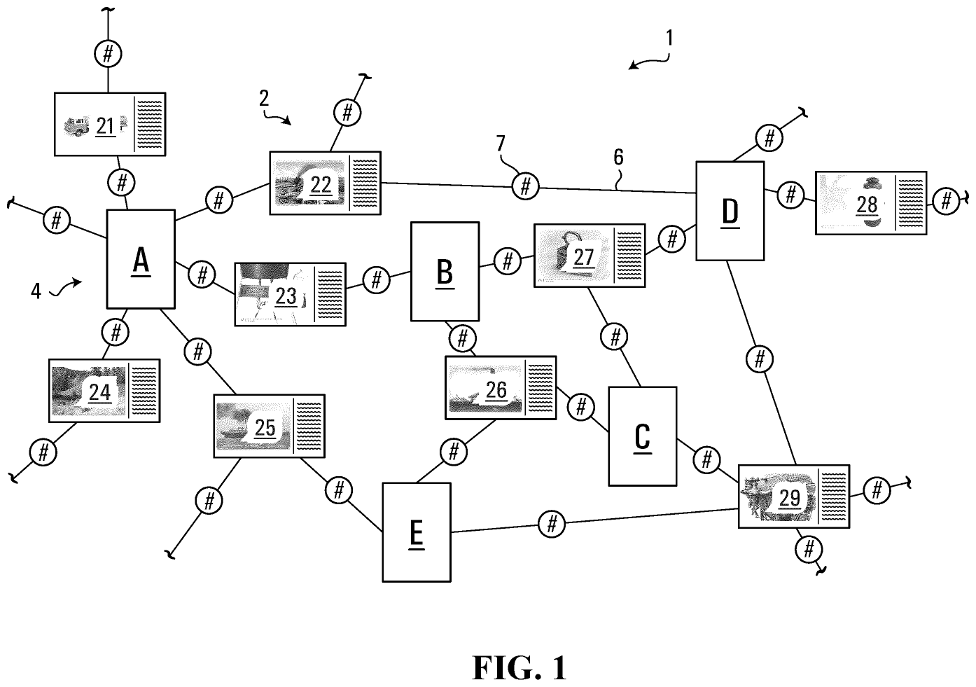

Aspects of this disclosure are now described with reference to a first embodiment comprising an exemplary relational database 1 conceptually shown in FIG. 1 as a weighted nodal network. As shown, relational database 1 may comprise: a plurality of vignettes 2 marked 21-29; a plurality of stories 4 marked A-E; and a plurality of tags 6 associating various vignettes 2 with stories 4.

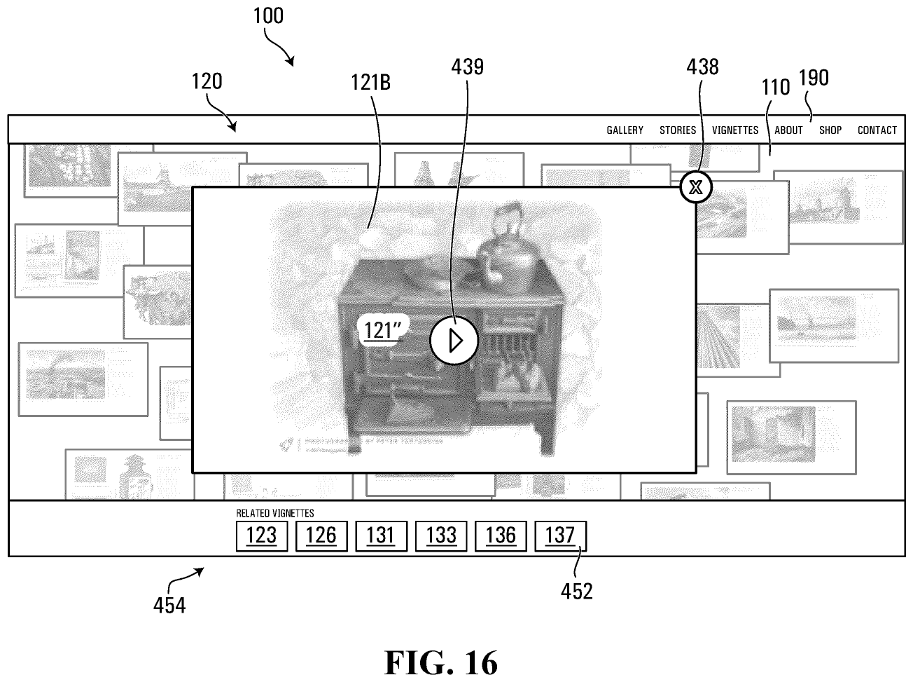

As shown in FIG. 1, each vignette 2 (or more generally, each structured object) may comprise a first view or face comprising content, such as images and/or text. As shown in FIG. 16 and described further below, each vignette 2 also may comprise a second view or face comprising additional content, such as one or more assets 8 related to the content on the first view or face. Each story 4 may comprise content related to plurality of vignettes 2, including longer narratives comprising more content (e.g., more images and/or text) related to one or more vignettes 2. Each tag 6 is shown conceptually in FIG. 1 as a line extending between each vignette 2 and one or more stories 4. As shown, each tag 6 may comprise a weighting variable 7 shown conceptually in FIG. 1 as a circle with a “#” symbol on the line. Weighting variables 7 may indicate a degree of relevancy between at least two items in relational database 1, including any vignette 2 and story 4 having at least one common tag 6 therebetween (e.g., as indicated by lines in FIG. 1).

Each tag 6 may comprise a reference associated with at least two items in relational database 1, as shown in FIG. 1, in which the line representing each tag 6 extends between one vignette 2 and one story 4. Each reference may comprise a category, theme or identifier (e.g. an alphanumeric sequence). For example, each vignette 2 may comprise energy related content, and some of tags 6 may comprise categorical references to the energy related content, such as “coal,” “oil,” “renewable,” and the like. A title of any story 4 also may be used as a reference for any vignette 2 and vice versa. Each weighting variable 7 may indicate a degree of relevancy between the reference (e.g., the category, theme, or identifier) and at least two items in database 1. In various embodiments, each weighting variable 7 may be assigned by a user (e.g., such as via administrative interface 10 discussed below). In other embodiments, various weighting variables 7 may be preconfigured or automatically assigned based on predetermined values or scores defining various relationships between at least two categories, stories, and/or any combination thereof.

A relevancy score may be calculated between any items in relational database 1 based on tags 6 and their weighting variables 7. As shown in FIG. 1, for example: story A may be about oil production and vignette 21 may be about oil tankers, with weighting variable 7 between story A and vignette 21 having a high relevancy score (e.g., 9 out of 10) because oil production is directly related to oil tankers; and vignette 22 may be about coal production, with weighting variable 7 between story A and vignette 22 having a low relevancy score (e.g., 4 out of 10) because oil production is indirectly related to coal production. In this example, because the reference of each tag 6 is story A, the relevancy score between story A and vignettes 21 and 22 may be equal to their weighting variables 7.

A relevancy score also may be determined between any two vignettes 2 sharing at least one tag 6. For example, the reference of one tag 6 may comprise the term “oil,” with weighting variable 7 between oil tag 6 and vignette 21 having a high relevancy score (e.g., 10 out of 10) because it is directly related to oil; and weighting variable 7 between oil tag 6 and vignette 22 having a low relevancy score (e.g., 4 out of 10) because it is indirectly related to oil. In this example, the relevancy score between vignette 21 and vignette 22 may be equal to a sum of a first percentage (e.g., 100%) of weighting variable 7 between vignette 21 and oil tag 6 plus a second percentage (e.g., 50%) of weighting variable 7 between vignette 22 and oil tag 6, or (1.00×10)+(0.50×4)=12.

Any algorithm and/or calculations may be used to calculate the relevancy scores, including these examples and/or any known methods.

### Administrative Interface 10

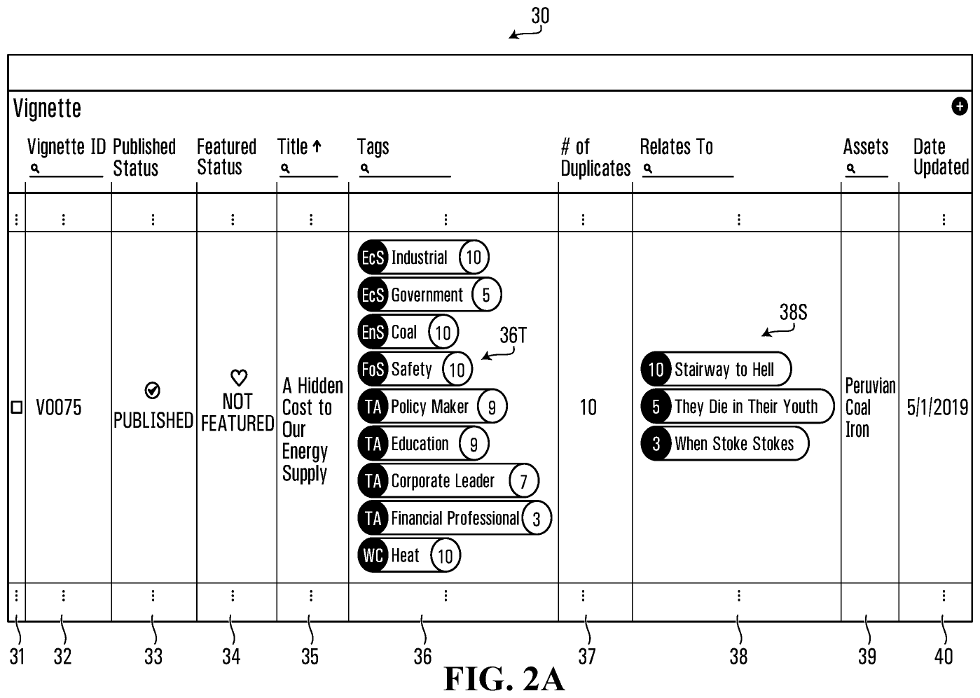

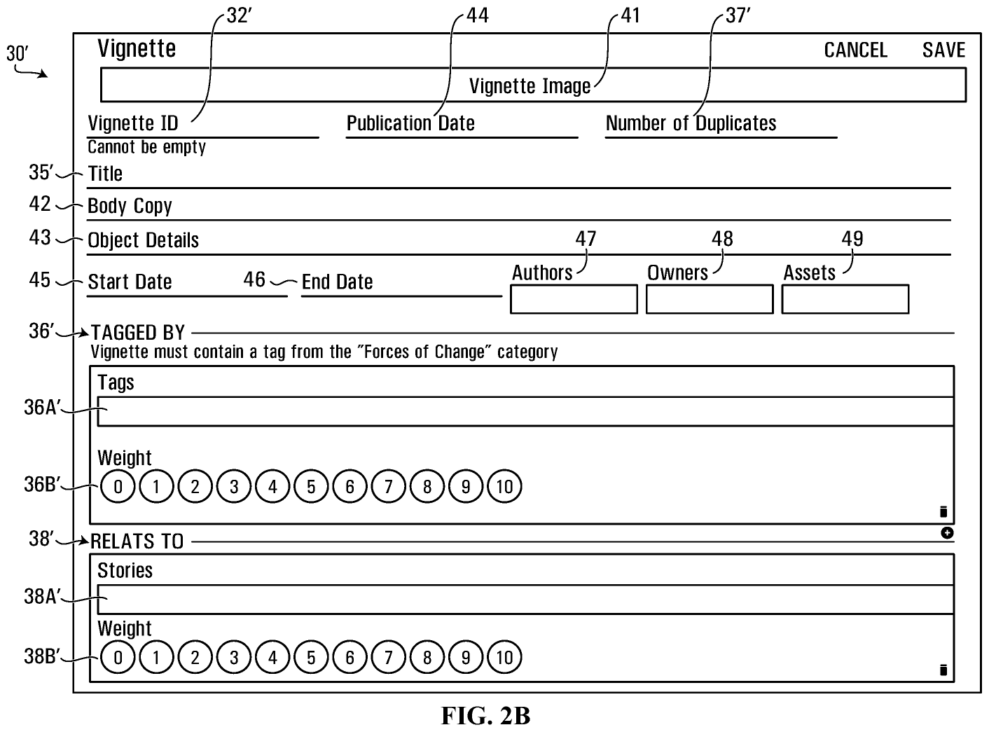

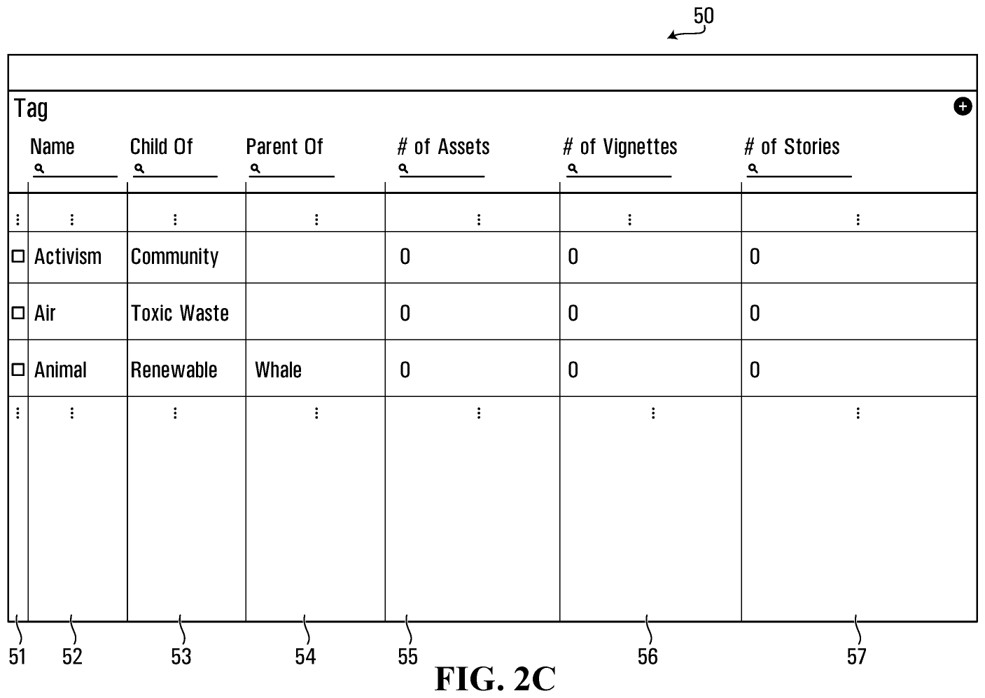

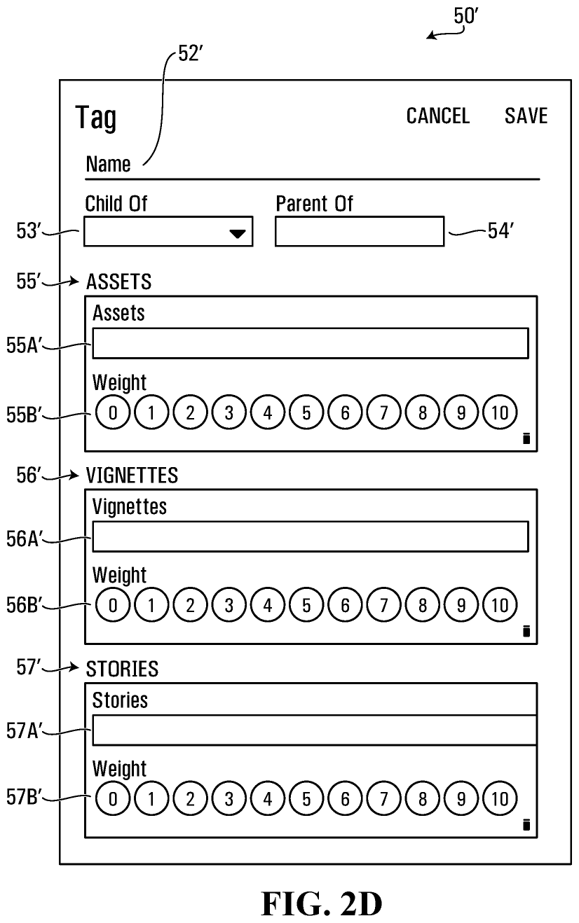

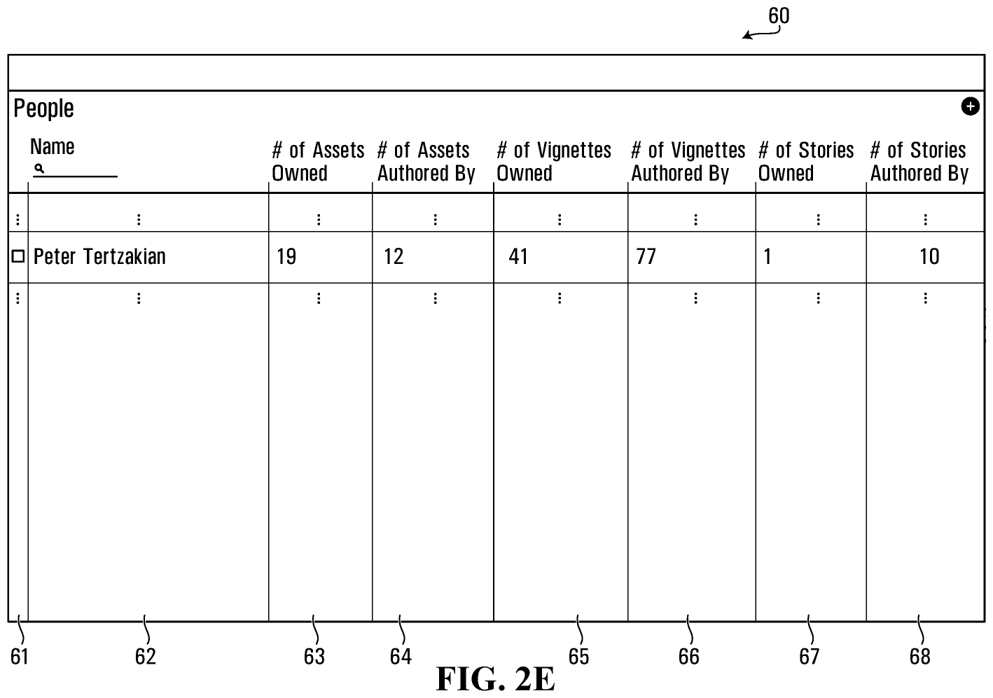

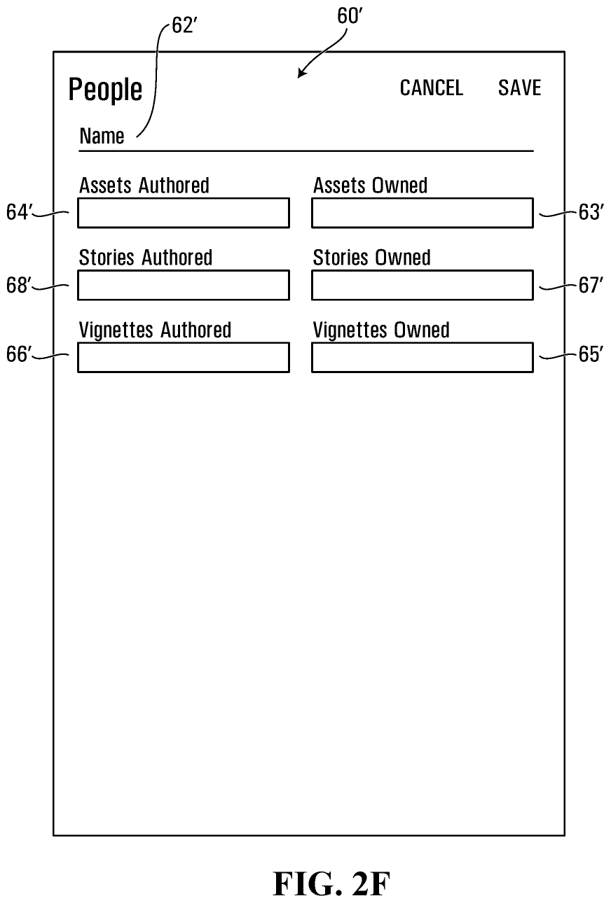

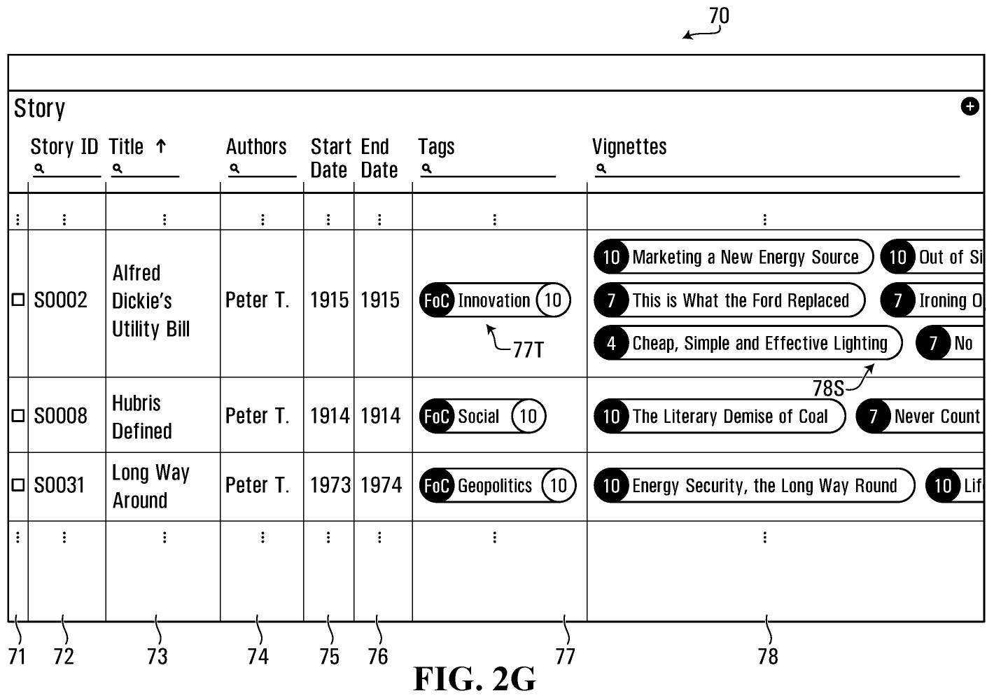

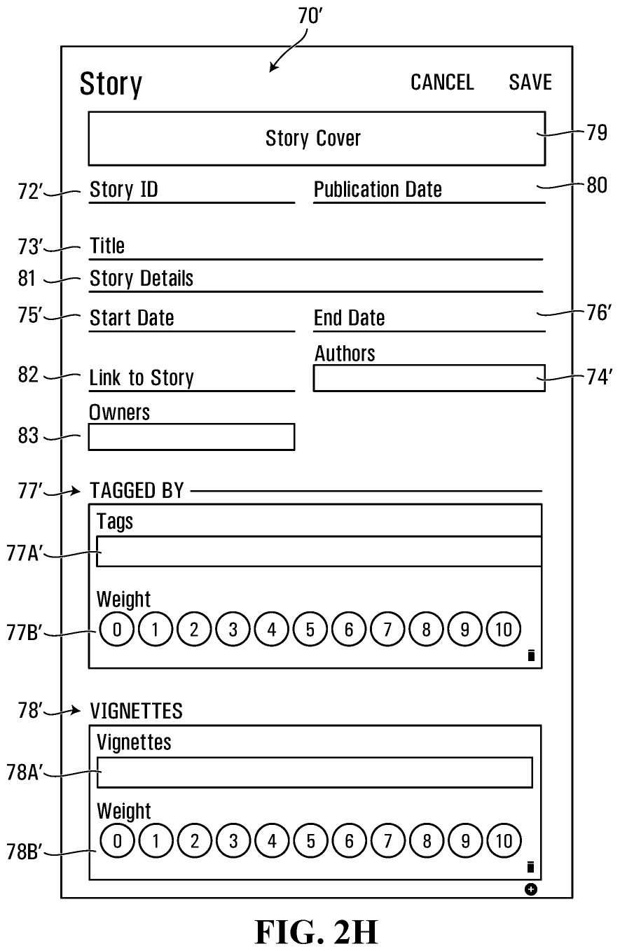

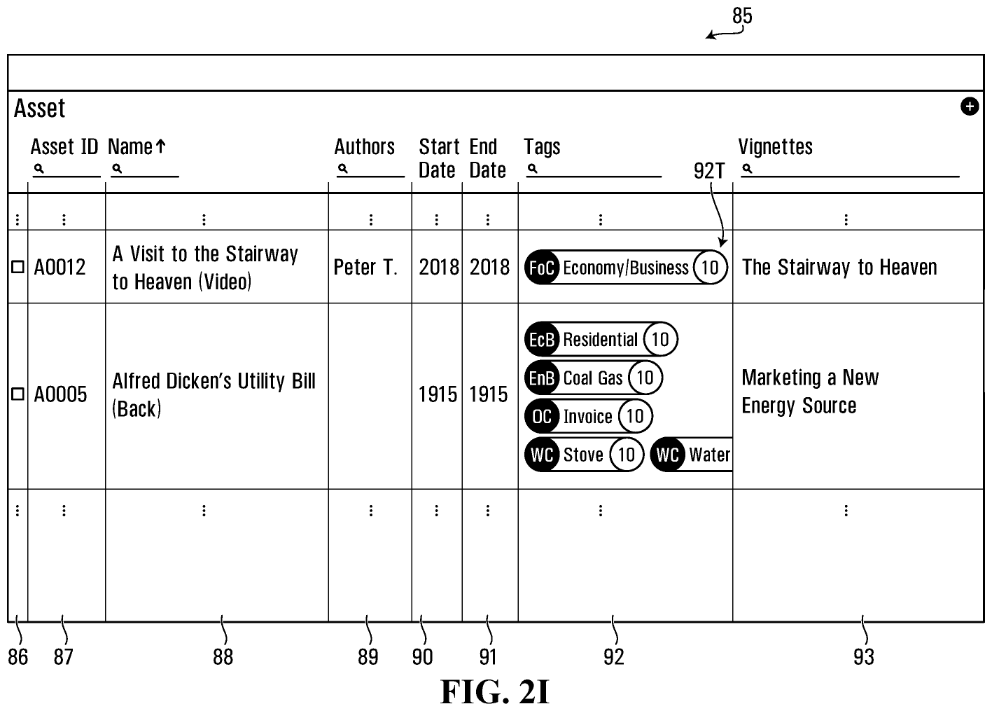

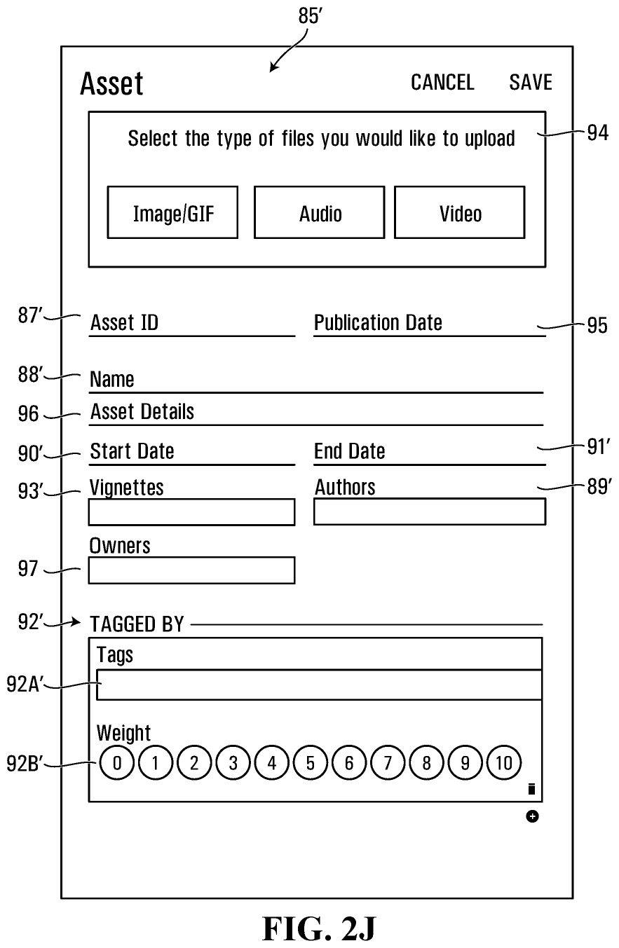

In various embodiments, relational database 1 may be accessible to a user via a computer-implemented graphical user interface or “GUI” displayed via a display device. Aspects of an exemplary GUI are now described with reference to an administrative interface 10 shown in FIGS. 2A-2J. Some aspects are described with reference to vignettes 2, stories 4, tags 6, and assets 8; while other aspects are described with reference another exemplary GUI operable with administrative interface 10, such as another computer-implemented graphical interface 100 shown in FIGS. 3-16 as comprising a plurality of vignettes 120. Each vignette 2 and 120 may be interchangeable so that administrative interface 10 may be described as a “back end” for graphical interface 100, which may be likewise described as a “front end” for administrative interface 10, the combination of which may be operably configured to display a visual representation including any portion of vignettes 2, vignettes 120, and/or similar structured objects.

Administrative interface 10 may comprise a plurality of functional portions, such as: a vignette access portion 30 shown in FIG. 2A; a vignette edit portion 30′ shown in FIG. 2B; a tag access portion 50 shown in FIG. 2C; a tag edit portion 50′ shown in FIG. 2D; a people access portion 60 shown in FIG. 2E; a people edit portion 60′ shown in FIG. 2F; a story access portion 70 shown in FIG. 2G; a story edit portion 70′ shown in FIG. 2H; an asset access portion 85 shown in FIG. 2I; and an asset edit portion 85′ shown in FIG. 2J. For example, in various embodiments each access portion 30-85 and edit portion 30′-85′ may comprise a different system and/or mechanism to interface with relational database 1, such as a different screen with different display and/or input capabilities.

As shown in FIG. 2A, vignette access portion 30 may comprise a plurality of fields configured to organize data related to each vignette 2 and associate each vignette 2 with one or more stories 4, tags 6, and/or assets 8. For example, vignette access portion 30 may comprise: (i) selection fields 31 for selecting each vignette 2 for various purposes (e.g., editing, deleting, etc.); (ii) vignette fields 32 indicating a unique identifier for each vignette 2; (iii) status fields 33 indicating a publication status for each vignette 2; (iv) status fields 34 indicating a featured status for each vignette 2; (v) title fields 35 indicating a title for each vignette 2; (vi) tag fields 36 indicating one or more tags 36 associated with each vignette 2 (e.g., like tags 6 of FIG. 1); (vii) duplicate fields 37 indicating a number of instances that each vignette 2 should be displayed; (viii) story fields 38 indicating a relevancy score 38S between each vignette 2 and one or more stories 4; (ix) asset fields 39 indicating one or more assets 8 associated with each vignette 2; and (x) update fields 40 indicating a last update for each vignette 2. In various embodiments, the vignette access portion 30 may comprise one or more of the foregoing fields.

Any of fields 31-40 of vignette access portion 30 may be populated by any available mechanism or technique, including text entry, selection menus, and the like. For example, selection fields 31 may be populated via selection boxes. Some of fields 32-40 of access portion 30 may be populated based on other portions of administrative interface 10 and/or displayed in a read-only form on portion 30.

One example is now described with reference to vignette edit portion 30′ of FIG. 2B. As shown, vignette edit portion 30′ may comprise input fields corresponding with any of fields 32-40 of vignette access portion 30, such as: (i) a vignette input field 32′ for populating vignette fields 32; (ii) a title input field 35′ for populating title fields 35; (iii) a tag input field 36′ for populating tag fields 36; (iv) a duplicate input field 37′ for populating duplicate fields 37; and (v) a story input field 38′ for populating story fields 38.

Vignette edit portion 30′ also may comprise additional input fields, such as: (i) an image input field 41 for associating an image file with each vignette 2; (ii) a body copy input field 42 for associating a body of text with each vignette 2; (iii) an object details input field 43 for associating additional text with each vignette 2; (iv) a publication date input field 44 for associating a publication date with each vignette 2; (v) a start date input field 45 for associating a start date with each vignette 2; (vi) an end date input field 46 for associating an end date with each vignette 2; (vii) an author input field 47 for associating one or more authors with each vignette 2; (viii) an owner input field 48 for associating one or more owners with each vignette 2; and (ix) an asset input field 49 for associating one or more assets with each vignette 2. In various embodiments, vignette edit portion 30′ may comprise one or more of the foregoing fields. In various embodiments, one or more of the foregoing fields may be populated via text entry, selection menu, or the like; or, where predefined data has been collected, via automated tools.

As shown in FIG. 2A, each tag 36T may comprise a category component (e.g., “EcS” for “Economic Sector”), a subcategory component (e.g., “Industrial”), and a weighting variable 7 (e.g., a value out of 10 or some other score) indicating a degree of relevancy between each vignette 2 and the subcategory components. Accordingly, tag input field 36′ of FIG. 2B may comprise a selection menu 36A′ including category and subcategory combinations, and selection boxes 36B′ for associating weighting variable 7 with each combination. As also shown in FIG. 2A, each relevancy score 38S may comprise an identifier for each story 4 (e.g., the title “Stairway to Hell”), and a weighting variable 7 (e.g., a value out of 10 or some other score) indicating a degree of relevancy between the identified story 4 and one of vignettes 2. Accordingly, story input field 38′ also may comprise a selection menu 38A′ including the identifiers for each story 4, and selection boxes 38B′ for associating weighting variable 7 with each identifier.

As shown in FIG. 2C, tag access portion 50 may comprise a plurality of fields configured to define relationships between tags 6 and track data related to each tag 6, including any tags 36T described above and/or tags 77T and 92T described below. For example, tag access portion 50 may comprise: (i) selection fields 51 for selecting each tag 6 for various purposes (e.g., editing, deleting, etc.); (ii) name fields 52 indicating a unique identifier for each tag 6; (iii) child fields 53 indicating a forward lineage of each tag 6; (iv) parent fields 54 indicating a backward lineage of each tag 6; (v) count fields 55 tracking a number of assets 8 associated with each tag 6; (vi) count fields 56 tracking a number of vignettes 2 associated with each tag 6; and (v) count fields 57 tracking a number of stories 5 associated with each tag 6. In various embodiments, tag access portion 50 may comprise one or more of the foregoing fields.

As shown in FIG. 2C, name fields 52, child fields 53, and parent fields 54 may define a hierarchical system for tags 6, allowing the user to better understand the relationships therebetween. Any hierarchical order or structure may be used, including any number of levels. Aspects of the hierarchical system also may be used to display vignettes 2, as described below with reference to display method 200.

Any of fields 51-57 of tag access portion 50 may be populated by any available mechanism or technique. For example, selection fields 51 may be populated via selection boxes. Some of fields 52-57 of access portion 50 may be populated based on other portions of administrative interface 10 and/or displayed in a read-only form on portion 50. One example is now described with reference to tag edit portion 50′ of FIG. 2D. As shown, tag edit portion 50′ may comprise input fields corresponding with any of fields 52-57 of tag access portion 50, such as: (i) a name input field 52′ for populating name fields 52; (ii) a child input field 53′ for populating child fields 53; (iii) a parent input field 54′ for populating parent fields 54; (iv) an asset input field 55′ for populating count fields 55; (v) a vignette input field 56′ for populating count fields 56; and (vi) a story input field 57′ for populating count fields 57.

As shown in FIG. 2D, input fields 55′, 56′, and 57′ may be used to relate each tag 6 with one or more assets 8, vignettes 2, and stories 4, respectively. For example, asset input field 55′ may comprise a selection menu 55A′ including identifiers for each asset 8 and selection boxes 55B′ for associating a weighting variable 7 with each identifier; vignette input field 56′ may comprise a selection menu 56A′ including identifiers for each vignette 2 and selection boxes 56B′ for associating a weighting variable 7 with each identifier; and story input field 57′ may comprise a selection menu 57A′ including identifiers for each story 4 and selection boxes 57B′ for associating a weighting variable 7 with each identifier.

As shown in FIG. 2E, people access portion 60 may comprise a plurality of fields configured to identify one or more persons and track data related thereto. For example, people access portion 60 may comprise: (i) selection fields 61 for selecting each person for various purposes (e.g., editing, deleting, etc.); (ii) name fields 62 indicating a name of each person; (iii) count fields 63 tracking assets 8 owned by each person; (iv) count fields 64 tracking assets 8 authored by each person; (v) count fields 65 tracking vignettes 2 owned by each person; (vi) count fields 66 tracking vignettes 2 authored by each person; (vii) count fields 67 tracking stories 4 owned by each person; and (viii) count fields 68 tracking stories 4 authored by each person.

Any of fields 61-68 of people access portion 60 may be populated by any available mechanism or technique. For example, selection fields 61 may be populated via selection boxes. Some of fields 62-68 of access portion 60 may be populated based on other portions of administrative interface 10 and/or displayed in a read-only form on portion 60. One example is now described with reference to people edit portion 60′ of FIG. 2F. As shown, people edit portion 60′ may comprise input fields corresponding with any of fields 62-68 of tag access portion 60, such as: (i) a name input field 62′ for populating name fields 62; (ii) a count input field 63′ for populating count fields 63; (iii) a count input field 64′ for populating count fields 64; (iv) a count input field 65′ for populating count fields 65; (v) a count input field 66′ for populating count fields 66; (vi) a count input field 67′ for populating count fields 67; and (vii) a count input field 68′ for populating count fields 68. Portion 60 also may comprise additional fields, as needed. In various embodiments, people access portion 60 may comprise one or more of the foregoing fields. In various embodiments, one or more of the foregoing fields may be populated via text entry, selection menu or the like or, where predefined data has been collected, via automated tools.

As shown in FIG. 2G, story access portion 70 may comprise a plurality of fields configured to organize data related to each story 4, and associate each story 4 with one or more vignettes 2 and tags 6. For example, story access portion 70 may comprise: (i) selection fields 71 for selecting each story 4 for various purposes (e.g., editing, deleting, etc.); (ii) story fields 72 indicating a unique identifier for each story 4; (iii) title fields 73 indicating a title for each story 4; (iv) author fields 74 indicating an author of each story 4; (v) start date fields 75 indicating a start date for each story 4; (vi) end date fields 76 indicating an end date for each story 4; (vii) tag fields 77 indicating one or more tags 77T associated with each story 4 (e.g., like tags 6 of FIG. 1); and (viii) vignette fields 78 indicating a relevancy score 78S between each story 4 and one or more vignettes 2. In various embodiments, story access portion 70 may comprise one or more of the foregoing fields.

Any of fields 71-78 of story portion 70 may be populated by any available mechanism or technique. For example, selection fields 71 may be populated via selection boxes. Some of fields 72-78 of access portion 70 may be populated based on other portions of administrative interface 10 and/or displayed in a read-only form on portion 70. One example is now described with reference to story edit portion 70′ of FIG. 2H. As shown, story edit portion 70′ may comprise input fields corresponding with any of fields 72-78 of story access portion 70, such as: (i) a story input field 72′ for populating story fields 72; (ii) a title input field 73′ for populating title fields 73; (iii) an author input field 74′ for populating author input fields 74; (iv) a start date input field 75′ for populating start date fields 75; (v) an end date input field 76′ for populating end date fields 76; (vi) a tag input field 77′ for populating tag fields 77; and (vii) a vignette input field 78′ for populating vignette fields 78.

Story edit portion 70′ also may comprise one or more additional input fields, such as: (i) an image input field 79 for associating an image file with each story 4 (e.g., a story cover); (ii) a publication date input field 80 for associating a publication date with each story 4; (iii) a story details input field 81 for associating text with each story 4; (iv) a story link input field 82 for associating a link to each story; and (v) an owner input field 83 for associating one or more owners with each story 4. In various embodiments, one or more of the foregoing fields may be populated via text entry, selection menu or the like or, where predefined data has been collected, via automated tools.

As shown in FIG. 2G, each tag 77T may comprise a category component (e.g., “FoC” or “Force of Change”), a subcategory component (e.g., “Innovation”), and a weighting variable 7 (e.g., 10 out of 10) indicating a relevancy score between the story and the category and/or subcategory components. Accordingly, tag input field 77′ of FIG. 2H may comprise a selection menu 77A′ including each category and subcategory combination and selection boxes 77B′ for associating weighting variable 7 with each combination. As also shown, each relevancy score 78S may comprise an identifier for each vignette 2 (e.g., “Marketing a New Energy Source”), and a weighting variable 7 (e.g., 10 out of 10) indicating a degree of relevancy between the identified vignette 2 and a selected story 4. Accordingly, vignette input field 78′ also may comprise a selection menu 78A′ including the identifiers for each vignette 2 and selection boxes 78B′ for associating weighting variable 7 with each identifier.

As shown in FIG. 2I, asset access portion 85 may comprise a plurality of fields configured to organize data related to assets 8, and associate each asset 8 with one or more tags 6 and vignettes 2. For example, asset access portion 85 may comprise: (i) selection fields 86 for selecting each asset 8 for various purposes (e.g., editing, deleting, etc.); (ii) asset fields 87 indicating a unique identifier for each asset 8; (iii) name fields 88 indicating a name for each asset 8; (iv) author fields 89 indicating one or more authors for each asset 8; (v) start date fields 90 indicating a start date for each asset 8; (vi) end date fields 91 indicating an end date for each asset 8; (vii) tag fields 92 indicating one or more tags 92T associated with each asset 8 (e.g., like tags 6 of FIG. 1); and (viii) vignette fields 93 indicating one or more vignettes 2 associated with an asset 8. In various embodiments, asset access portion 85 may comprise one or more of the foregoing fields.

Any of fields 86-93 may be populated by any available mechanism or technique. For example, selection fields 86 of asset access portion 85 may be populated via selection boxes. Some of fields 87-93 of access portion 85 may be populated based on other portions of administrative interface 10 and/or displayed in a read-only form on portion 85. One example is now described with reference to asset edit portion 85′ of FIG. 2J. As shown, asset edit portion 85′ may comprise input fields corresponding with any of fields 87-93 of asset access portion 85, such as: (i) an asset input field 87′ for populating asset fields 87; (ii) a name input field 88′ for populating name fields 88; (iii) an author input field 89′ for populating author fields 89; (iv) a start date input field 90′ for populating start date fields 90; (v) an end date input field 91′ for populating end date fields 91; (vi) a tag input field 92′ for populating tag fields 92; and (vii) a vignette input field 93′ for populating vignette fields 93.

Asset edit portion 85′ also may comprise additional input fields, such as: (i) a content input field 94 for associating one or more digital assets (e.g., an image file, an audio file, and/or a video file) with each asset 8; (ii) a publication date input field 95 for associating a publication date with each asset 8; (iii) an asset details input field 96 for associating additional text with each asset 8; and (iv) an owner input field 97 for associating one or more owners with each asset 8.

As shown in FIG. 2I, each tag 92T may comprise a category component (e.g., “FoC” or “Forces of Change”), a subcategory component (e.g., “Economy/Business”), and a weighting variable 7 (e.g., 10 out of 10) indicating a degree of relevance between each asset 8 and the subcategory components. Accordingly, tag input field 92′ of FIG. 2J may comprise a selection menu 92A′ including category and subcategory combinations, and selection boxes 92B′ for associating a weighting variable 7 with each combination.

As illustrated above, any data input to the fields of each access portion 30-85 of administrative interface 10 with one of edit portions 30′-85′ may be stored in relational database 1 so as to define a multi-dependent network of tags 6 with weighting variables 7. In some aspects, relational database 1 may be operable with a weighting system configured to display a visualization of plurality of vignettes 2 in a viewport of a display device (e.g., a computer monitor) based on tags 6 and weighting variables 7. As a further example, relational database 1 may be configured so that updating a field of administrative interface 10 will cause the update to take effect through any or all related content referencing or relying on the field that was changed. For example, the modification of any field of portions 30-85 of interface 10 (e.g., via edit portions 30′-85′) may cause corresponding modifications of other fields associated with the one field, allowing the user to iteratively create and refine aspects of relational database 1 over time, such as tags 6, weighting variables 7, and/or any resulting visualization of vignettes 2.

Any combination of hardware and/or software technologies may be utilized to implement relational database 1 and display vignettes 2. In one particular example, relational database 1 may be implemented as an open-source framework, such as a GraphQL endpoint (e.g., available at www.graph.cool), operable to: (a) generate API calls (e.g. to create, read, update, and delete records from database 1); (b) implement resolver functions for listening to specific updates (e.g., related to vignettes 2, stories 4, and/or assets 8); and (c) cause a generation of cropped layers of an image of each vignette 2 to be stored in a storage device such as on a server. For example, the server may comprise a structure for storing any files associated with vignettes 2 (e.g., image files), with any assets 8 associated with one of the vignettes 2 (e.g., audio files, image files, video files). As a further example, in various embodiments the server may comprise an Amazon S3 Bucket; an Amazon Lambda function may be utilized to resize image files and/or other assets; and the server may utilize any intermediate systems to display different visualizations of plurality of vignettes 2.

### Graphical Interface 100

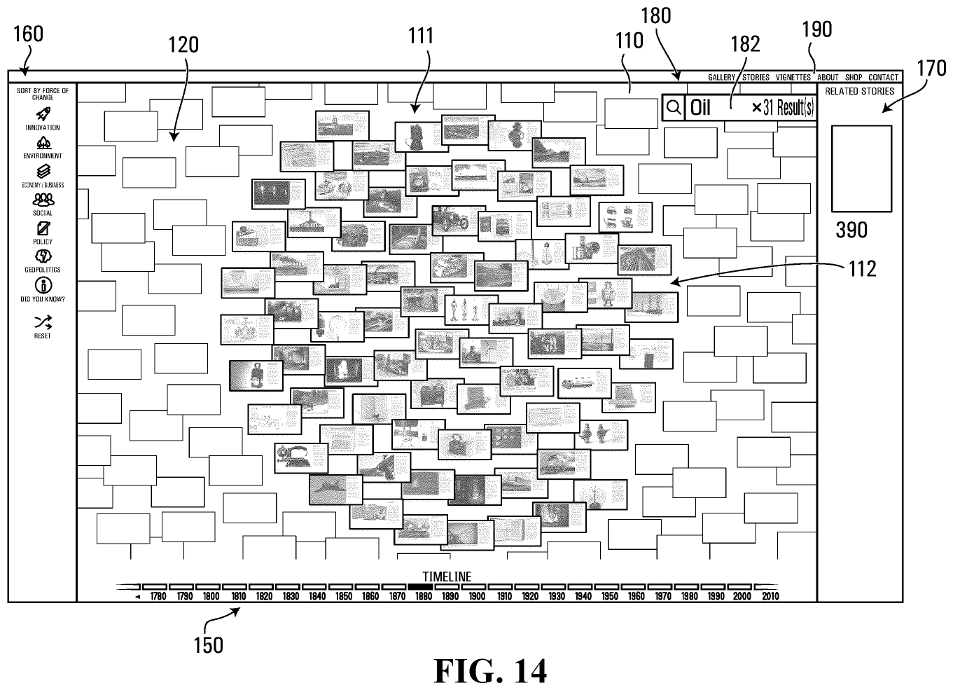

Aspects of exemplary graphical interface 100 are now described. In various embodiments, graphical interface 100 may comprise a visualization of plurality of vignettes 2 that is generated based on relational database 1, and displayable on a display device (e.g., a computer monitor). As shown in FIGS. 3-16, in some aspects graphical interface 100 may comprise: a selector 102; a viewport 110; a plurality of vignettes 120 displayable in viewport 110; a timeline interface 150; a category interface 160; a story interface 170; a search interface 180 (e.g., FIG. 14); and a menu interface 190.

Selector 102 may comprise any selection tool that is movable in viewport 110 responsive to signals from an input device, such as a mouse, a touchscreen, a touchpad and/or other form of input device(s). As shown in FIG. 3, in some aspects selector 102 may have a hand-like shape, in which a selection point 103 of selector 102 is defined by a tip of a finger of the hand-like shape. Any selector shape may be utilized. Selector 102 may be movable about and operable with any part of graphical interface 100 responsive to the signals from the input device, including any part of viewport 110, vignettes 120, and interfaces 150-190.

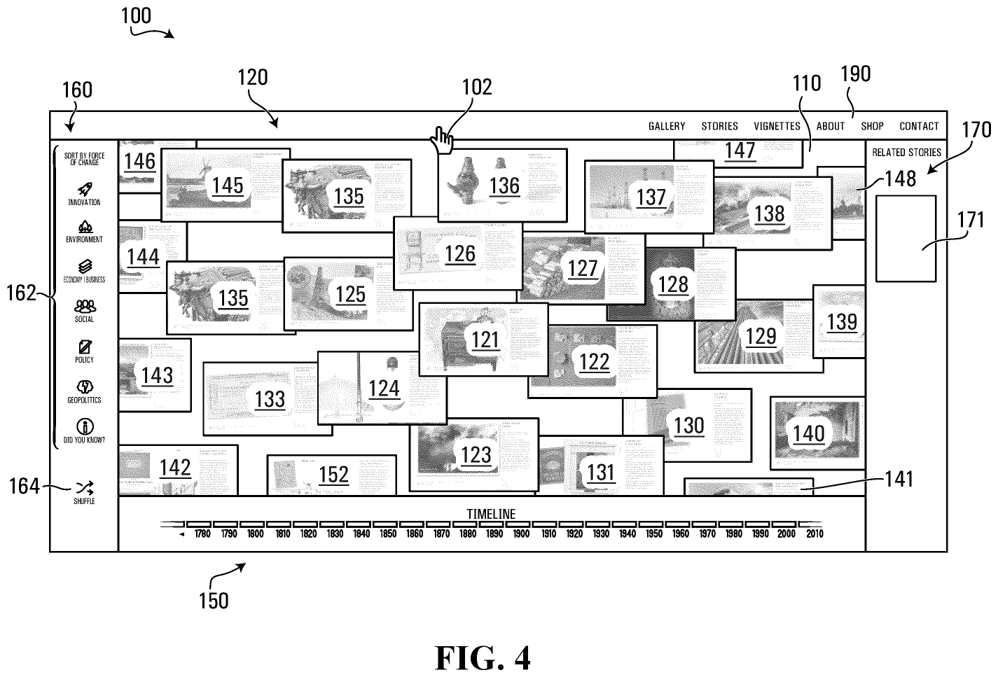

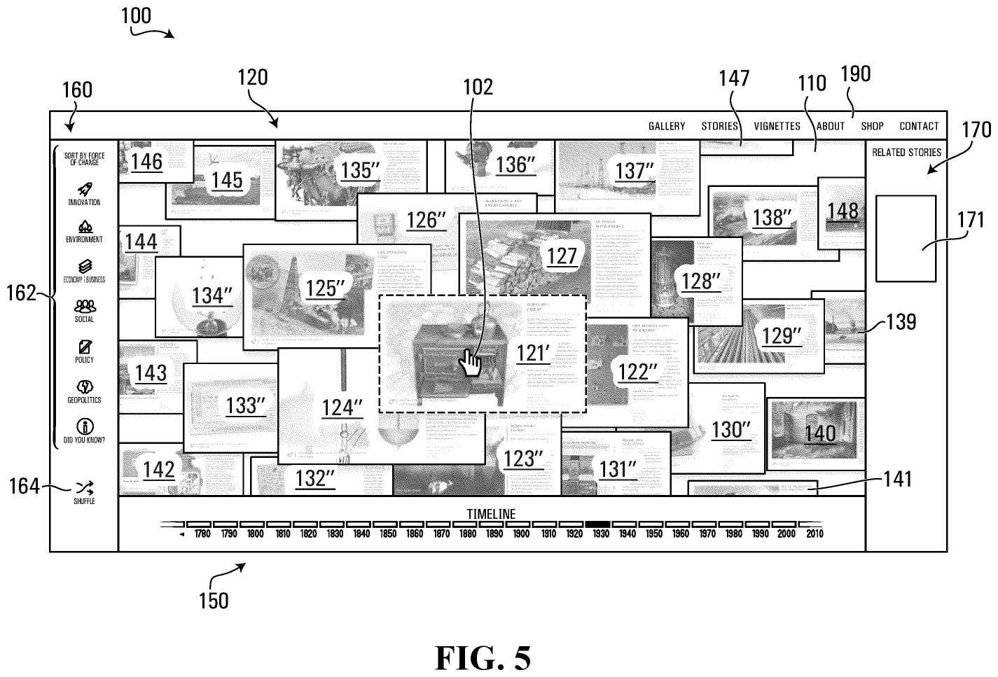

As shown in FIG. 3, viewport 110 may provide a framed viewing area for the visualization of plurality of vignettes 120. As shown, the framed viewing area may comprise a generally central portion of graphical interface 100. Viewport 110 may be adjustable independent of the remainder of graphical interface 100, responsive to signals from the input device (e.g., from a mouse such as a scroll wheel of the mouse or some other input mechanism associated with the mouse or other input device). For example, without changing the size or location of interfaces 150-180, viewport 110 may be adjusted so that all of vignettes 120 are viewable at once, as shown in FIG. 3; or so that only a portion of vignettes 120 is viewable at once, as in FIGS. 4-5.

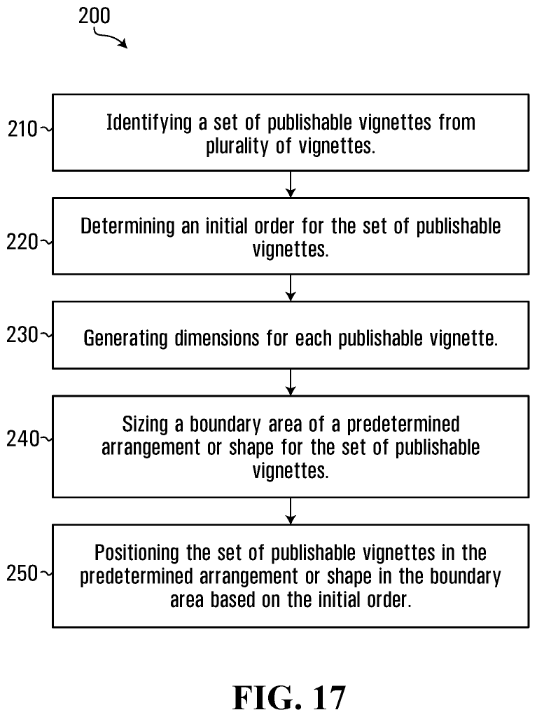

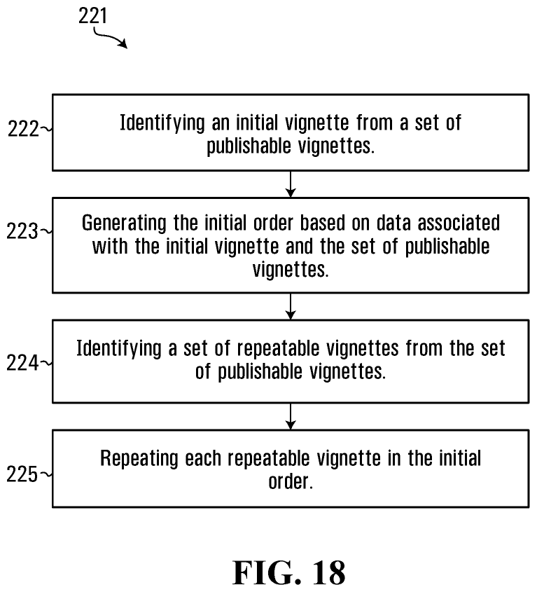

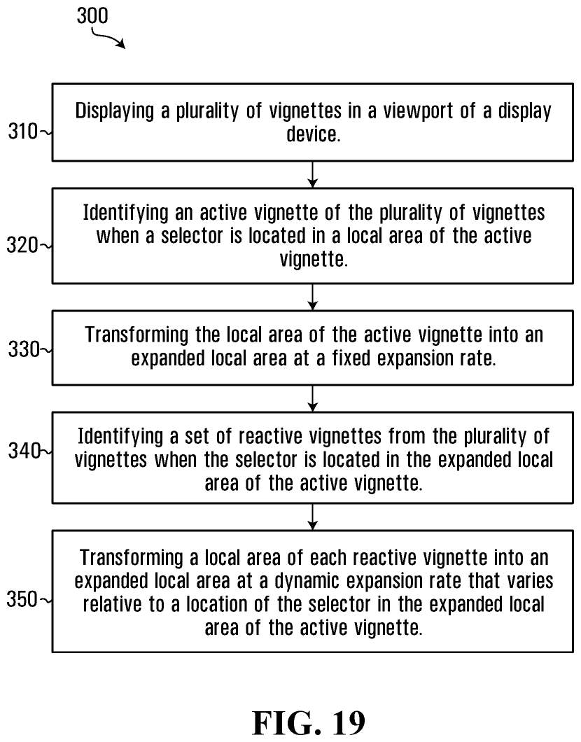

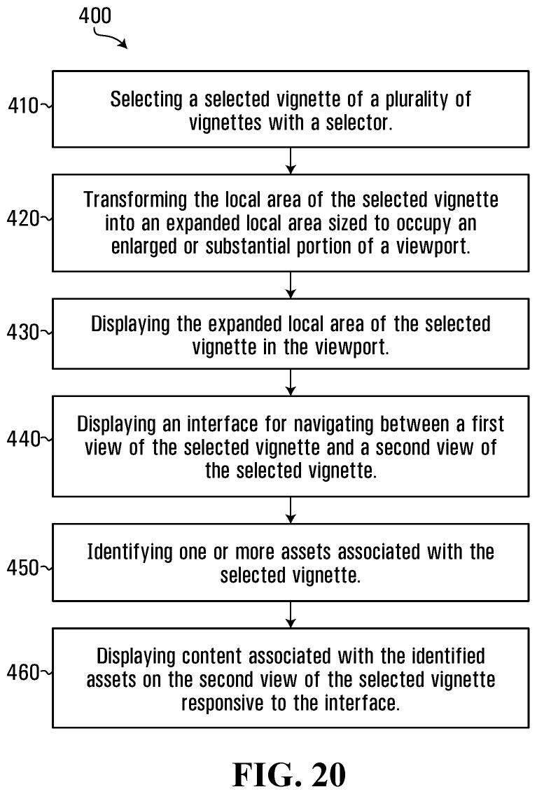

Additional aspects of graphical interface 100 are now described with reference to: (i) a computer-implemented display method 200 shown in FIG. 17; (ii) a computer-implemented ordering method 221 shown in FIG. 18; (iii) a computer-implemented navigation method 300 shown in FIG. 19; and (iv) a computer-implemented display method 400 shown in FIG. 20. For ease of description, aspects of interfaces 150-190 are described after methods 200-400.

Display Method 200

Display method 200 may be performed to implement aspects of graphical interface 100. In some aspects, display method 200 may comprise arranging plurality of vignettes 120 in a predetermined arrangement or shape in viewport 110 based on data in relational database 1. The contents of each first view or face of each vignette 120 may be displayed in viewport 110. As shown in FIG. 3, in various embodiments the predetermined arrangement or shape may be a spiral shape and plurality of vignettes 120 may be overlapped in the spiral shape. For ease of description, some aspects of display method 200 are described with reference to the spiral shape, although any type of predetermined arrangement or shape may be utilized.

As shown in FIG. 17, in various embodiments display method 200 may comprise: (i) identifying a set of publishable vignettes from plurality of vignettes 120 (an “identifying step 210”); (ii) determining an initial order for the set of publishable vignettes 120 (a “determining step 220”); (iii) generating dimensions for each publishable vignette 120 (a “dimensioning step 230”); (iv) sizing a boundary area of the predetermined arrangement or shape for the set of publishable vignettes 120 (a “sizing step 240”); and (v) positioning the set of publishable vignettes 120 in the predetermined arrangement or in the boundary area based on the initial order (a “positioning step 250”).

In various embodiments, the initial order represents an order in which any set of vignettes 120 has been placed once they have been sorted. In various embodiments, the set of publishable vignettes 120 may be related to a subset of data in relational database 1, and each vignette 120 that matches or has data that falls within the subset of data may be identified as part of the set of publishable vignettes 120. In other embodiments, the set of publishable vignettes 120 may have been designated in the relational database 1 as being ready for display. In the example that follows, display method 200 makes use of the set of publishable vignettes 120. However, identifying a set of publishable vignettes 120 is optional. For example, another set of vignettes 120 may be identified by any means (e.g., instead of a set of publishable vignettes), and method 200 may be similarly applied to that set.

Identifying step 210 of display method 200 may comprise any available mechanism or technique for identifying (or distinguishing) the set of publishable vignettes from plurality of vignettes 120. Any portion of vignettes 120 may be identified in identifying step 210 and thus included in the set of publishable vignettes 120. For example, step 210 may comprise identifying the set of publishable vignettes 120 based on identifying which of the plurality of vignettes have one or more tags assigned to them (e.g. 36T in FIG. 2A).

Determining step 220 of display method 200 may comprise determining the initial order based on any data in relational database 1. For example, in various embodiments, all relevant vignettes may be sorted, in accordance with any sort criteria, in a list of elements to place onto the spiral shape when vignettes are displayed. In other embodiments, determining step 220 may comprise an ordering process 221.

As shown in FIG. 18, in some embodiments ordering process 221 may comprise: (i) identifying an initial vignette from the set of publishable vignettes 120 (an “identifying step 222”); and (ii) generating the initial order based on data associated with the initial vignette and the set of publishable vignettes 120 (a “generating step 223”). In various embodiments, certain steps may be performed sequentially or in parallel.

Identifying step 222 of ordering process 221 may comprise any available identification mechanism or technique. For example, identifying step 222 may comprise randomly identifying the initial vignette from the set of publishable vignettes 120. Identifying step 222 also may be based on search criteria. Different search criteria may be utilized to redefine the initial order with process 221. For example, identifying step 222 also may comprise receiving different search criteria (e.g., from interface 180) and identifying a new initial vignette from any set of vignettes 120 based on the different search criteria.

Identifying step 222 also may comprise identifying a set of related vignettes from the set of publishable vignettes 120, wherein the set of related vignettes are related to the initial vignette. For example, each related vignette may have tags, categories or other properties that are common to the initial vignette. As a further example, step 222 may comprise utilizing the category and/or subcategory components of tags 6 to identify the set of related vignettes.

Generating step 223 of ordering process 221 may be based on any data associated with the initial vignette and/or the set of publishable vignettes 120. In some aspects, generating step 223 may comprise defining the initial order based on the category and/or subcategory components of any tag 6, including any of tags 36T or 77T. For example, generating step 223 may comprise: grouping each publishable vignette 120 based on the category components of each tag 6 associated therewith; and/or ordering each publishable vignette 120 (e.g., in each grouping) based on the subcategory components and/or weighting variables 7 of each tag 6. Similar steps may be performed with the set of related vignettes. In some aspects, generating step 223 also may comprise defining the initial order based on a time period associated with each related vignette 120. For example, generating step 223 may comprise defining the initial order based on data input to start date input field 45 and end date input field 46 of vignette edit portion 30′ (e.g., FIG. 2B).

Generating step 223 of ordering process 221 also may comprise: identifying a set of repeatable vignettes 120 (or more generally, repeatable structured objects) from the set of publishable vignettes 120 (an “identifying step 224”); and repeating each repeatable vignette 120 in the initial order (a “repeating step 225”). The set of repeatable vignettes 120 may be identified from the set of publishable vignettes 120 in step 224 based on data input to duplicate count fields 37 (more generally, a multiple count field) of vignette edit portion 30′. Note that while reference in this specification is made to “duplicate”, the concept of duplication is meant to cover any number of instances being reproduced. More generally, copies of repeatable vignettes may be generated multiple times, resulting in multiple instances of the same vignettes. In this regard, duplicate count fields 37 may be utilized in step 225 to determine a sense of scarcity among the set of publishable vignettes 120 by modifying a frequency of each vignette 120 in the initial order. The set of repeatable vignettes 120 may enhance the learning experience by providing a larger volume of vignettes 120 to discover, such as when vignettes 120 are displayed to a user via viewport 110. Generating step 223 may comprise increasing the boundary area of the predetermined arrangement or shape to accommodate multiple instances of the same vignettes (or structured objects).

Each repeatable vignette 120 may be repeated in the initial order by any available mechanism or technique. For example, each repeatable vignette 120 may be randomly dispersed in the initial order. As a further example, generating step 223 may comprise: assigning each repeatable vignette 120 a key (e.g., such as V0001, V0023 . . . ); generating copies of each repeatable vignette 120 based on duplicate count fields 37 (more generally, a multiple count field); modifying each key so that each copy of each repeatable vignette 120 comprises a unique key (e.g., by adding a trailing number); and distributing the copies in the initial order based on the unique keys. Different distributions may be used. For example, step 223 may comprise defining the initial order so that: a generally central portion of the predetermined arrangement or shape in viewport 110 comprises the set of publishable vignettes 120 without repetition; and peripheral portions of the predetermined arrangement or shape in viewport 110 comprise the set of repeatable vignettes 120. As a further example, in various embodiments the set of publishable vignettes 120 in the generally central portion may be ordered non-randomly (e.g., based on relevancy), whereas the repeatable vignettes 120 in the peripheral portions may be ordered randomly.

Generating step 223 may comprise steps for including additional sets of vignettes 120 in a similar manner. For example, plurality of vignettes 120 also may comprise a set of advertising vignettes 120 that comprise advertising content, including pictures, text, and the like. The set of advertising vignettes 120 may create opportunities to monetize aspects of graphical interface 100. For example, the set of advertising vignettes 120 may be repeatable (e.g., based on data input to duplicate count fields 37) so as to increase their frequency in interface 100 and thus their potential value to the advertiser. As before, the set of advertising vignettes 120 may be ordered randomly or non-randomly.

Returning to display method 200, dimensioning step 230 may comprise determining a set minimum dimensions of and/or dimensional ratios for each publishable vignette 120, any of which may be stored in relational database 1.

Sizing step 240 of display method 200 may comprise: establishing a final count for the set of publishable vignettes 120; specifying a gap size between each publishable vignette 120; and calculating a size of the boundary area based on the final count, the minimum gap size, and/or a set of minimum dimensions and/or dimensional ratios for the boundary area, all of which may be stored in relational database 1. Sizing step 240 may comprise steps for managing the size of the boundary area. For example, step 240 may comprise either: minimizing the size of the boundary area of the predetermined arrangement or shape by establishing a maximum number for the set of related vignettes 120 and limiting the set of related vignettes 120 accordingly; or maximizing the size of the boundary area by repeating additional vignettes 120.

Positioning step 250 of display method 200 may comprise determining or specifying additional characteristics of the predetermined arrangement or shape. If the predetermined arrangement or shape is a spiral shape, as in FIG. 3, then positioning step 250 may comprise determining a rotational position of each publishable vignette 120 in the spiral shape. For example, the position of each publishable vignette 120 in positioning step 250 for the spiral shape may be calculated as follows:
// the gap between each item
   gapMultiplier=0.85;
   rotation=11;
// initial ring count
   incrementRing=6;
   cellWidth=220;
   cellHeightRatio=0.5624;
   const rotateX=
   Math. cos((((item*(360/ringCounts[step]))+(step*rotation))*Math.PI)/180);
   const rotateY=
   Math.sin((((item*(360/ringCounts[step]))+(step*rotation))*Math.PI)/180);

Positioning step 250 of display method 200 also may comprise positioning each publishable vignette 120 in the predetermined arrangement or shape based on the initial order. Any repeatable vignettes may be likewise positioned in the predetermined arrangement or shape based on the initial order. Any positioning mechanism or technique may be used. For example, step 250 also may comprise positioning the set of relevant vignettes 120 in a generally central portion of the predetermined arrangement or shape and positioning each remaining vignette 120 outwardly from the generally central portion.

Any combination of hardware and/or software technologies may be utilized to implement graphical interface 100. In one particular example, graphical interface 100 may be created using React.js, Canvas, Konva, Apollo, a physics engine, and sorting algorithms. For example, the physics engine may be configured to determine the boundary area in sizing step 240, specify a drag velocity for the predetermined arrangement or shape, and centre the predetermined arrangement or shape in the boundary area in positioning step 250; Apollo may be utilized throughout graphical interface 100 to query data from the GraphQL endpoint and/or administrative interface 10; and the sorting algorithms may be utilized in positioning step 250 to modify the initial order without modifying the predetermined arrangement or shape. As a further example, the physics engine also may be configured to scale a selected one of vignettes 120 and/or centre it in viewport 110.

In one particular example, various functions may be utilized to determine how plurality of vignettes 120 will be positioned in positioning step 250. For the spiral shape of FIG. 3, for example, these functions may comprise:
“calculateCellBounds”—gets the location of the item in the grid and the area it takes up based off of its scale.
“inertialRelease”—adds friction and determines if the item is outside of a visualization boundary.
“resizeImage”—resizes an item if it is expanded and the browser is being resized.
“loadImage”—loads an image from a memory (e.g., from Amazon) in a desired resolution.
“isFullscreen”—removes/adds content when in full-screen mode.
“getPositioning”—every item utilizes this function to determine its location in the Spiral.
“moveGridTo”—calculates the required velocity to add and spread spiral movement over animation frames, and recursively updates location of Spiral until there is no velocity existing in app state.
“setExpandedBoundary”—if there is an expanded item in the visualization it will increase the size of the visualization boundaries.

Aspects of the predetermined arrangement or shape may be modified after completion of positioning step 250. Different types of input methods may be utilized. For example, a location of the predetermined arrangement or shape in viewport 110 may be modified by a movement process comprising one or more of the following: (i) selecting a portion of the predetermined arrangement or shape (e.g., by clicking a button of the mouse when selector 102 is located over one of vignettes 120); (ii) maintaining the selection (e.g., by holding the button); (iii) performing a movement of the predetermined arrangement or shape while maintaining the selection; (iv) determining a velocity of the movement; (v) upon releasing the selection (e.g., by releasing the button), adding friction to slow the velocity of the movement; and (vi) if the velocity is still non-zero and the boundary of viewport 110 is hit, then reversing the non-zero velocity to move the predetermined arrangement or shape back into the boundary.

### Navigation Method 300

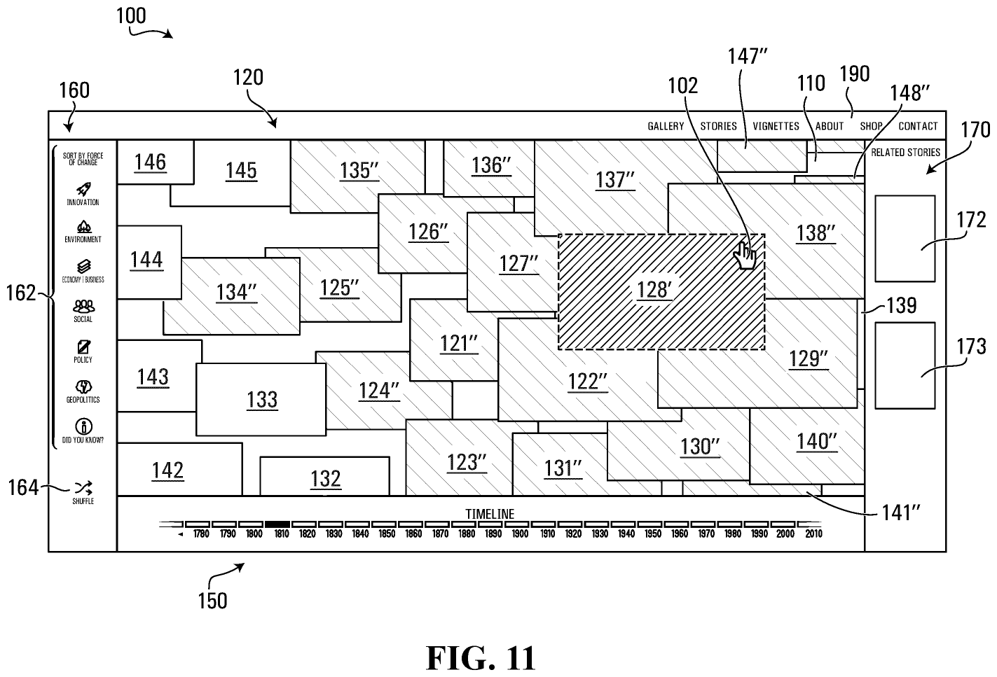

Navigation method 300 may be performed with one or more processors to implement aspects of graphical interface 100. Aspects of navigation method 300 now described with reference to FIGS. 5-11, which show an active vignette 121′ (or active structured object) identified from plurality of vignettes 120 (or plurality of structured objects) and a set of reactive vignettes 120″ (or set of reactive structured objects) identified from the plurality of vignettes 120. As noted below with reference to FIG. 11, these aspects may be similarly described with reference any one of plurality of vignettes 120.

As shown in FIG. 19, navigation method 300 may comprise: (i) displaying plurality of vignettes 120 in viewport 110 (a “displaying step 310); (ii) identifying active vignette 121′ from the plurality of vignettes 120 when selector 102 is located in a local area of active vignette 121′ (an “identifying step 320”); (iii) transforming the local area of active vignette 121′ into an expanded local area at a fixed expansion rate (“a transforming step 330”); (iv) identifying a set of reactive vignettes 120″ from the plurality of vignettes 120 when selector 102 is located in the expanded local area of active vignette 121′ (an “identifying step 340”); and (v) transforming a local area of each reactive vignette 120″ into an expanded local area at a dynamic expansion rate that varies relative to a location of selector 102 in the expanded local area of active vignette 121′ (a “transforming step 350”).

Displaying step 310 of navigation method 300 may be performed by any available mechanism or technique, including display method 200 and any other mechanism or technique for arranging and/or positioning plurality of vignettes 120 in viewport 110.

Identifying step 320 of navigation method 300 may comprise tracking the location of selector 102 in viewport 110. For example, identifying step 320 may comprise receiving signals from an input device (e.g., a mouse, a touchscreen, and/or other known input device(s)), and locating selector 102 in viewport 110 based on the signals. Identifying step 320 also may comprise determining whether selector 102 is hovering over and/or otherwise engaged with the active vignette 121′. For example, step 330 may comprise determining when selector 102 enters the local area of active vignette 121′ (or any other vignette 120) by determining when selector 102 crosses or engages any boundary or proximity of active vignette 121′.

Transforming step 330 of navigation method 300 may be applied similarly to each vignette 120, adding consistency to the learning experience provided by graphical interface 100. To achieve a form of consistency, the fixed expansion rate may be a constant quantity in transforming step 330. For example, the local area of vignette 121 in FIG. 4 may be multiplied by the constant quantity (e.g., by 150%) in step 330, thereby transforming it into the enlarged local area of active vignette 121′ in FIG. 5 whenever selector 102 is located in the local area of vignette 121 in FIG. 4. Without departing from this disclosure, the transformation implemented by transforming step 330 may occur at any rate of time, instant, gradual, or otherwise.

Identifying step 340 of navigation method 300 may be based on any data in relational database 1. As shown in FIG. 5, the set of reactive vignettes 120″ may comprise vignettes 122″-138″, each of which may be identified during step 340 based a rule-based relationship with active vignette 121′. The rule-based relationship may comprise one or more rule sets, including a geometry-based rule set. As also shown in FIG. 5, by way of example the set of reactive vignettes 120″ may not comprise vignettes 139-148, each of which may be described as a non-reactive vignette that was not identified during step 340 based on any rule set.

The geometry-based rule set may define an identification area relative to selector 102 and utilize the identification area to identify the set of reactive vignettes 120″. For example, the identification area may comprise a shape (e.g., a circular shape) that is centred on selection point 103 of selector 102 and movable with selector 102 in the expanded local area of active vignette 121′. Any relationship with the identification area (e.g., the circular shape) and plurality of vignettes 120 may be utilized in identifying step 340. As shown in FIG. 5, for example, reactive vignettes 122″-138″ may be identified during step 340, and thus included in the set of reactive vignettes 120″, because at least a portion of their local areas engages the identification area of selector 102 when located in a generally central portion of active vignette 121′.

Transforming step 350 of navigation method 300 may be applied to each vignette 120 in the set of reactive vignettes 120″ identified during identifying step 340, such as reactive vignettes 122″-138″. The dynamic expansion rate may be a variable quantity. For example, vignette 122 of FIG. 4 may be identified as reactive vignette 122″ during identifying step 340, and the local area of reactive vignette 122″ may be increased by the variable quantity during step 350, resulting in the dynamically expanded local area of reactive vignette 122″ in FIG. 5, which may be varied further responsive to selector 102. The variable quantity applied during step 350 may be different for each reactive vignette 120″. For example, the local area of reactive vignette 127″ may be increased by a different variable quantity than the local area of reactive vignette 122″, resulting in a dynamically expanded local area of vignette 127″ that is larger than the dynamically expanded local area of vignette 122″.

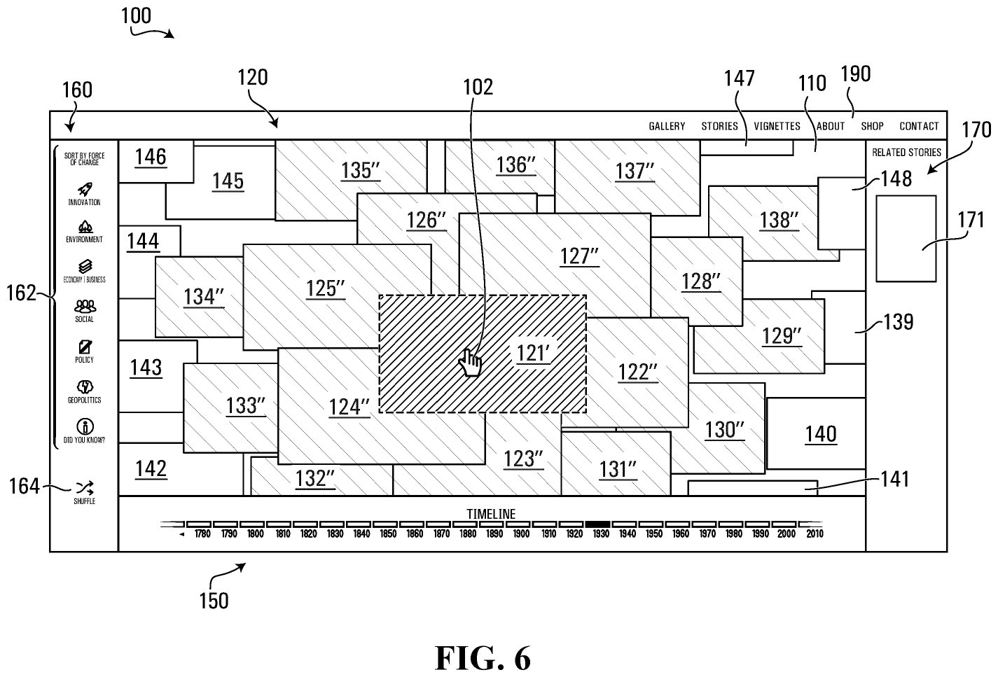

Additional aspects of transforming step 350 are now described with reference to FIGS. 6-10, which depict conceptual representations of graphical interface 100 in which the background images of vignettes 120 have been replaced with different types of hatching for ease of description. In this regard, FIG. 5 is a counterpart image to FIG. 6, in which active vignette 121′ has with a first type of hatching; reactive vignettes 122″-138″ have a second type of hatching; and non-reactive vignettes 139-148 do not have any hatching.

As shown in FIGS. 6-10, the dynamic expansion rate for each reactive vignette 120″ may be determined based one or more factors, such as a location of selector 102 in the expanded local area of active vignette 121′. Put another way, the expanded local area of active vignette 121′ may define a grid or local coordinate plane, and the variable quantity of each dynamic expansion rate for each reactive vignette 120″ may be continuously calculated based on the position of selector 102 in the grid or local coordinate plane. For example, each dynamic expansion rate may be calculated based on a distance between selection point 103 of selector 102 and a central and/or edge portion of the grid or local coordinate plane of active vignette 121′.

In the geometry-based rule set of identifying step 340, the variable quantity of each dynamic expansion rate also may be based on a location of each reactive vignette 120″ in the identification area. For example, if the identification area comprises the aforementioned circular shape, then the variable quantity of each reactive vignette 120″ may be determined based on the position of selector 102 in the grid or local coordinate plane of active vignette 121′ and a position of each reactive vignette 120″ in the identification area so that reactive vignettes 120″ closer to the expanded local area of active vignette 121′ (e.g., reactive vignette 127″ of FIG. 6) are expanded more and/or faster than reactive vignettes 120″ further away from the expanded local area of active vignette 121′ (e.g., reactive vignette 136″ of FIG. 6).

Because they were not identified during identifying step 340, the size of each non-reactive vignette 139-148 in FIGS. 6-10 may be similar and/or unchanged according to any rule-based relationships applicable thereto.

As shown in FIG. 6, display effects caused by the dynamic expansion rates may be fairly balanced when selector 102 is located in the generally central portion of active vignette 121′. For example, at this location of selector 102, the dynamic expansion rates applied to reactive vignettes 122″-127″ may be approximately equal so that their expanded local areas are approximately the same size. Reactive vignettes 128″-138″ may be similarly highlighted. For example, because they are further away from active vignette 121′, the dynamic expansion rates applied to reactive vignettes 128″-138″ may be smaller than those applied to reactive vignettes 122″-127″, yet still approximately equal so that their expanded local areas are smaller than those of vignettes 122″-127″ and yet still approximately the same size.

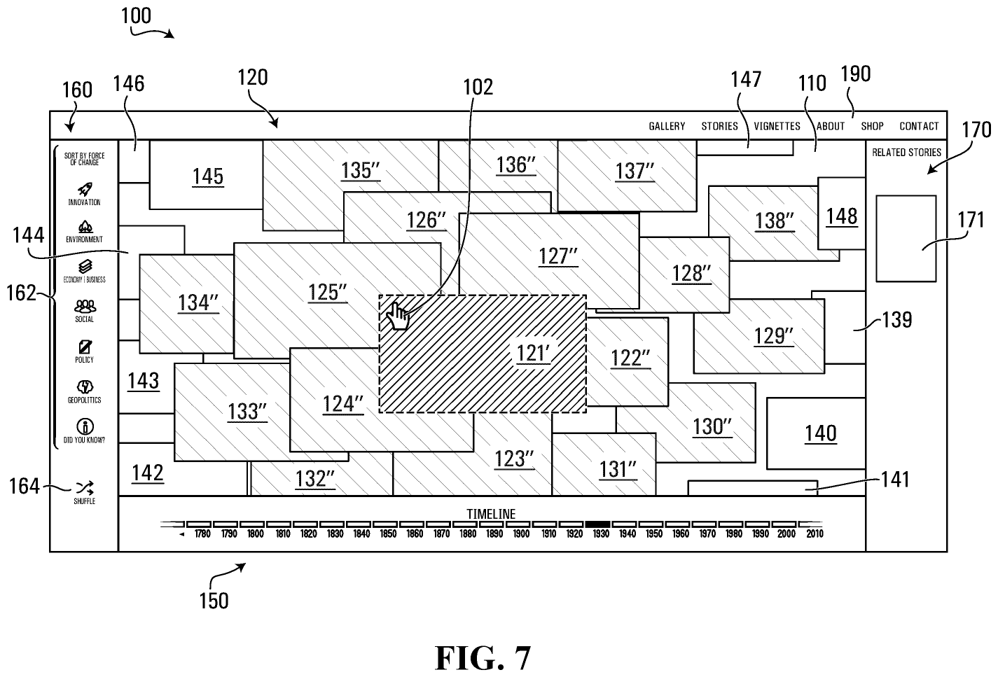

The dynamic expansion rates for the set of reactive vignettes 120″ may be modified when selector 102 is moved outside of the generally central portion of active vignette 121′, as shown in FIGS. 7-10, where selector 102 is located in different portions of the expanded local area of active vignette 121′. This functionality provides an additional mechanism or technique for highlighting the set of reactive vignettes 120″ responsive to selector 102. As before, because they were not identified during step 340, the size of non-reactive vignettes 139-148 may be similar and/or unchanged in FIGS. 7-10 responsive to selector 102.

As shown in FIG. 7, selector 102 may be located in an upper-left portion of the expanded local area of active vignette 121′. For example, at this location, the dynamic expansion rates applied to reactive vignettes 124″, 125″, and 126″ may be larger than the dynamic expansion rates applied to reactive vignettes 122″, 123″, and 128″ so as to emphasize vignettes 124″, 125″, and 126″, and deemphasize vignettes 122″, 123″, and 128″. The emphasis may be demonstrated by comparing the sizes of vignettes 122″, 123″, and 128″ and vignettes 124″, 125″, and 126″ in FIGS. 6 and 7.

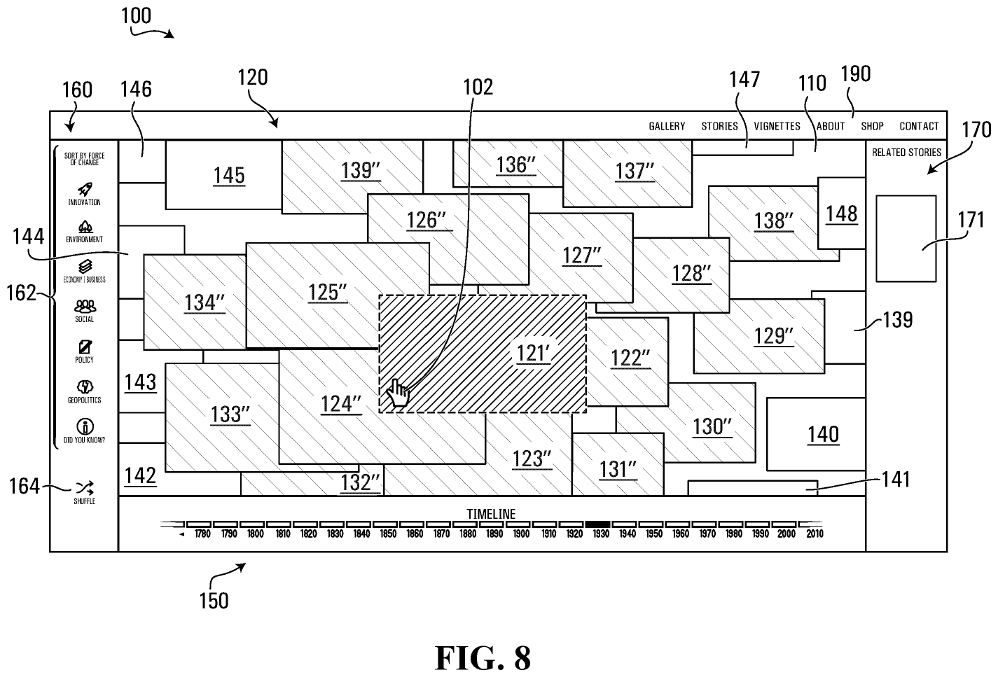

As shown in FIG. 8, selector 102 may be located in a lower-left portion of the expanded local area of active vignette 121′. For example, at this location, the dynamic expansion rates applied to reactive vignettes 123″, 124″, and 125″ may be larger than the dynamic expansion rates applied to reactive vignettes 122″, 127″, and 128″ so as to emphasize vignettes 123″, 124″, and 125″; and deemphasize vignettes 122″, 127″, and 128″. The emphasis may be demonstrated by comparing the sizes of vignettes 123″, 124″, and 125″ with vignettes 122″, 127″, and 128″ in FIGS. 7 and 8.

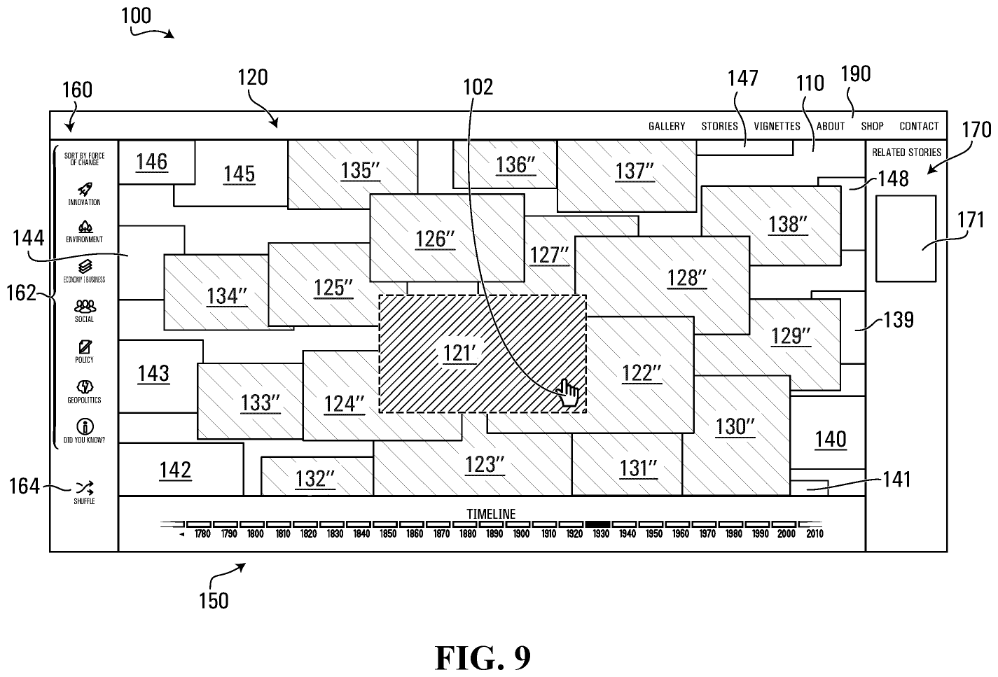

As shown in FIG. 9, selector 102 may be located in a lower-right portion of the expanded local area of active vignette 121′. For example, at this location, the dynamic expansion rates applied to reactive vignettes 122″, 123″, and 128″ may be larger than the dynamic expansion rates applied to reactive vignettes 124″, 125″, and 126″ so as to emphasize vignettes 122″, 123″, and 128″ and deemphasize vignettes 124″, 125″, and 126″. The emphasis may be demonstrated by comparing the size of the expanded local areas of vignettes 122″, 123″, and 128″ and vignettes 124″, 125″, and 126″ in FIGS. 8 and 9.

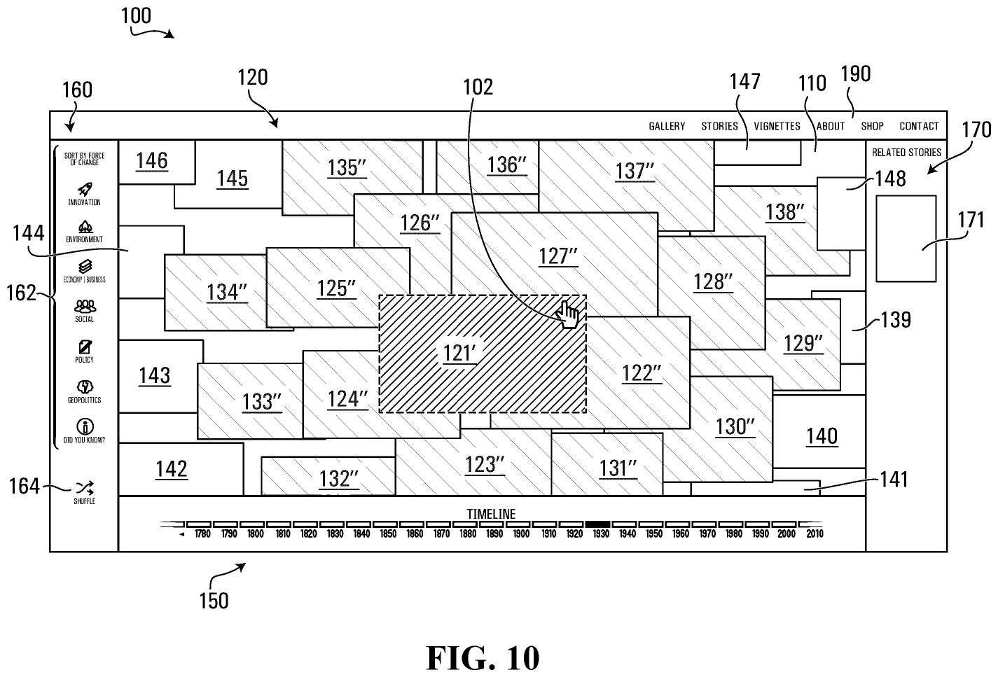

As shown in FIG. 10, selector 102 also may be located in an upper-right portion of the expanded local area of active vignette 121′. For example, at this location, the dynamic expansion rates applied to reactive vignettes 122″, 127″, and 128″ may be larger than the dynamic expansion rates applied to reactive vignettes 123″, 124″, and 125″ so as to emphasize vignettes 122″, 127″, and 128″ and deemphasize vignettes 123″, 124″, and 125″. The emphasis may be demonstrated by comparing the size of vignettes 122″, 127″, and 128″ and vignettes 123″, 124″, and 125″ in FIGS. 9 and 10.

Navigation method 300 may be repeated each time that selector 102 is located in the local area of any vignette 120. Another example is shown in FIG. 11, in which: vignette 128 was identified during identifying step 320 as a new active vignette 128′ when selector 102 was located in a local area of vignette 128; and the local area of active vignette 128′ was transformed during transforming step 330 into an expanded local area at a fixed expansion rate. The sizes of active vignette 128′ in FIG. 11 and active vignette 121′ in FIGS. 6-10 may be approximately equal.

Selector 102 is located in an upper-right portion of the expanded local area of new active vignette 128′ in FIG. 11. In this example, vignettes 121, 122, 123, 124, 125, 126, 127, 129, 130, 131, 134, 135, 136, 137, 138, 140, 141, 147 and 148 have been identified during identifying step 340 and now comprise a new set of reactive vignettes 120″. Accordingly, the local areas of new reactive vignettes 121″, 122″, 123″, 124″, 125″, 126″, 127″, 129″, 130″, 131″, 134″, 135″, 136″, 137″, 138″, 140″, 141″, 147″ and 148″ may be similarly transformed during transforming step 350 into expanded local areas at one or more dynamic expansion rates relative to the upper-right location of selector 102 in the expanded local area of the new active vignette 128′.

### Interfaces 150-190

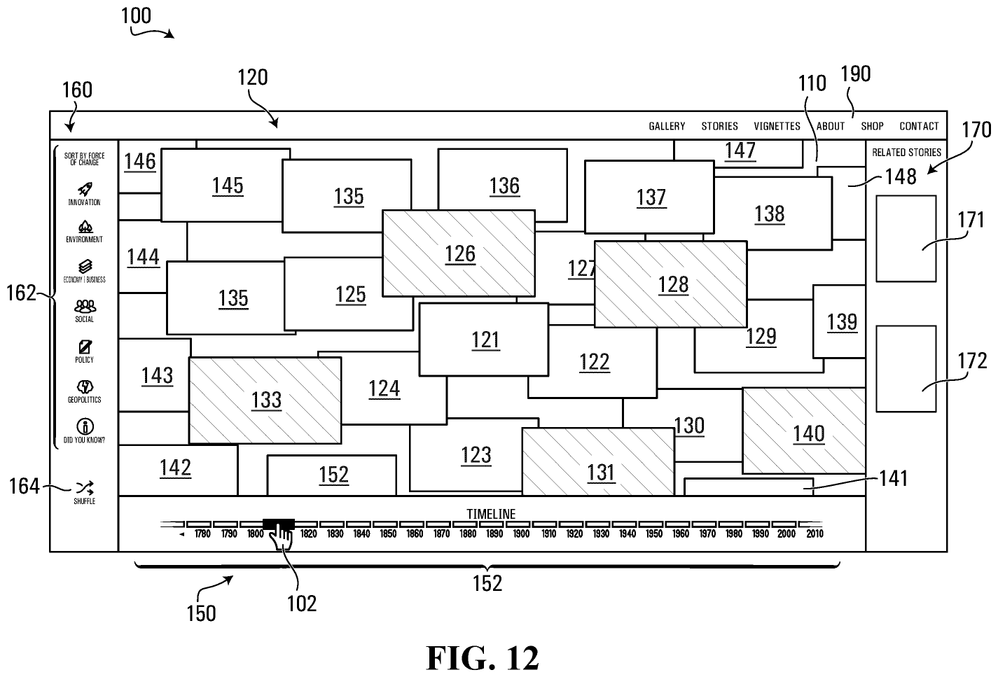

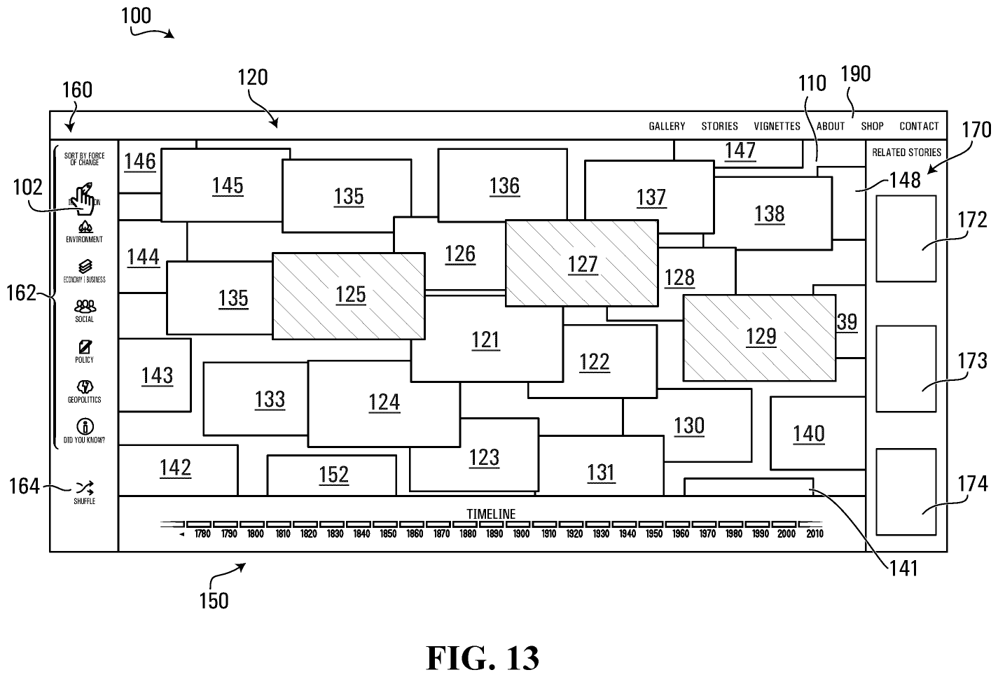

Aspects of timeline interface 150, category interface 160, story interface 170, search interface 180, and menu interface 190 are now described with reference to FIGS. 12, 13, and 14. As shown in FIGS. 12, 13, and/or 14, in various embodiments each timeline interface 150, category interface 160, story interface 170, and search interface 180 may provide different mechanisms or techniques for displaying, emphasizing or highlighting portions of vignettes 120 in viewport 110; and menu interface 190 may provide a mechanism or technique for accessing graphical interface 100.

As shown in FIG. 12, timeline interface 150 may comprise a plurality of time bars 152 representing different time periods (e.g., decades in this instance). Selector 102 may be utilized to select one of the time periods (e.g., by clicking on one of time bars 152), causing any vignettes 120 associated with that time period to be highlighted. Different highlighting methods may be used. In FIG. 12, for example, a cross-hatching has been added to vignettes 126, 128, 131, 133, and 140 to indicate that they have been highlighted. The highlighting methods also may comprise modifying a location of each associated vignette 120 in viewport 110. For example, similar to as shown in FIG. 3, each vignette 120 may be located in a predetermined arrangement or shape, and the highlighting methods may comprise moving each vignette 120 associated with a selected time period into a central region of the predetermined arrangement or shape. As a further example, each of vignettes 126, 128, 131, 133, and 140 of FIG. 12 may be similarly moved to a central portion of viewport 110.

Selecting one of time bars 152 may trigger a display method for displaying or highlighting vignettes associated with a select time bar. For example, the display method may comprise: identifying a relevant or highlighted set of vignettes associated with the selected time bar from plurality of vignettes 120 based on data input for each vignette 120 with respect to start date input field 45 and/or end date input field 46 (e.g., FIG. 2B); and causing each vignette 120 from the relevant or highlighted set of vignettes (referred to for illustration purposes as highlighted set of vignettes in the description that follows) to be displayed more prominently or in the absence of all other vignettes 120. In various embodiments, a relevant set of vignettes related to a specific time period may be displayed in a generally central portion of viewport 110. In other embodiments, for example, as in FIG. 12, a size and foreground position of each highlighted vignette 126, 128, 131, 133, and 140 may be modified. In various embodiments, any highlighting mechanism or technique may be used, such as modifying a visual property of each non-highlighted vignette 120 (or non-relevant vignette) for additional de-emphasis (e.g., by further modifying colors, sizes, and the like).

As shown in FIG. 13, category interface 160 may comprise a plurality of category icons 162 representing different categorical groupings of plurality of vignettes 120 (e.g., “innovation”). For example, the different categorical groupings may be determined based on the direct children of a selected tag 6 (e.g., based on the direct children of the “Forces of Change” tag 6). As a further example, any vignette 120 assigned with a specific tag 6 may be moved up in the hierarchy shown in FIG. 2C until it falls into one of the different categorical groupings.

Selector 102 may be utilized to select one of the different categorical groupings (e.g., by clicking on one of icons 162, such as the innovation icon of FIG. 13), causing any vignettes 120 associated with the selected categorical grouping to be highlighted. Different highlighting methods may be used. In FIG. 13, for example, a cross-hatching has been added to vignettes 125, 127, and 129 to indicate that they have been highlighted. In other embodiments, vignettes 120 associated with a selected categorical grouping may be redisplayed in a group generally in the centre of viewport 110. In various embodiments, any remaining vignettes 120 that are displayed in viewport 110, but not associated with the selected categorical grouping, may be displayed in a de-emphasized state. For example, in the de-emphasized state, each remaining vignette 120 may be greyed out or otherwise displayed as inactive.

Selecting one of category icons 162 may trigger a display method comprising: identifying a highlighted set of vignettes (e.g., a relevant set of vignettes) from plurality of vignettes 120 based on data input to tag field 36′ of vignette edit portion 30′ (e.g., FIG. 2B); and causing each highlighted vignette 120 to be modified, rearranged and/or resized, such as in FIG. 13 by way of example, where a size and foreground position of each highlighted vignette 125, 127, and 129 has been modified. Any highlighting mechanism or technique may be used, such as modifying a visual property of each non-highlighted vignette 120 for additional de-emphasis (e.g., by greying out or otherwise modifying colours, sizes, and the like). As shown in FIG. 13, category interface 160 also may comprise a shuffle or reset button 164 to reset vignettes across categories. In various embodiments, the highlighted vignettes associated with a tag, category or other identifier may be re-arranged and displayed in a generally central portion of viewport 110 (by way of example, in a manner similar to the display of select vignettes in a generally central grouping).

As shown in FIGS. 12 and 13, story interface 170 may comprise links to related stories 4. The links may be generated based on whatever vignettes 120 are displayed in viewport 110. For example, in various embodiments, related stories 4 associated with a particular vignette 120 may be displayed in story interface 170 as a result of movement or location information being detected indicating that selector 102 has been moved over or is located in a part of viewport 110 where particular vignette 120 is displayed. If particular 120 is selected, then related stories 4 may remain displayed in story interface 170. As a further example, when one of time bars 152 is selected as in FIG. 12, story interface 170 may comprise a first story link 171 and a second story link 172 displayed based on their relevancy to vignettes 126, 128, 131, 133, and 140.

Search interface 180 may allow the user to narrow the scope of discovery and/or find a specific vignette item by inputting search terms (e.g., keywords). As shown in FIG. 14, search interface 180 may be operable with a display method comprising: receiving search criteria via text entry into an input field 182 of search interface 180; identifying a set of highlighted vignettes 112 from plurality of vignettes 120 based on the search criteria; and causing each highlighted vignette 112 to be highlighted in viewport 110 by any available mechanism or technique. The search criteria may be split into keywords (e.g., space delimited) for identification and compared against any data associated with vignettes 120, including any data input to title input field 35′, tag input field 36′, body copy input field 42, and/or object details field 43 of vignette edit portion 30′ of administrative interface 10. The set of repeatable vignettes 120 may be omitted from the search. An exemplary AND/OR structure for the search may be as follows:

```
query: getAllVignettesBySearch,
  variables: {
  searchFilter: {
  OR: [
  generateFilter(′description′),
  generateFilter(′name′),
  generateFilter(′objectDetails′),
  {
  tags_some: {
  tag: {
  OR: [
  generateFilter(′name′),
  { childOf: generateFilter(′name′) },
  { childOf: { childOf: generateFilter(′name′) } },
  ],
  },
  },
  },
  ],
  },
  },
```

In this example, using the vignette field as a parameter, ‘generateFilter’ may return another match where the entered keywords are contained within all fields. As a further example, if the user enters the text string “Coal in Alberta,” then generating step 224 may comprise: breaking the string into keywords (e.g., “Coal”, “in”, “Alberta”); and generating sub filters (e.g., by way of example only, body copy input field 42 should contain (“Coal” AND “in” AND “Alberta”) or a case insensitive variation thereof). As shown in FIG. 14, the highlighting may comprise: (a) re-ordering all of the vignettes 120 in the predetermined arrangement or shape so as to group the set of highlighted vignettes 112 in a generally central portion 111 of viewport 110; and/or (b) modifying a visual property of each non-highlighted vignette 120 for additional de-emphasis (e.g., by making the images less visible as in FIG. 14).

Menu interface 190 may be operable with selector 102 to navigate between graphical interface 100 and between various functionalities available from the menu interface, using any known software technologies. As shown in FIGS. 12-14, interface 190 may comprise: (i) a gallery tab directing the user to graphical interface 100; (ii) a stories tab directing the user to a story interface; (iii) a vignettes tab directing the user to a vignette interface; (iv) an about tab directing the user to about content; (v) a contact tab directing the user to contact information; and (vi) a shop tab directing the user to a store interface. Any number of additional tabs may be included.

### Additional Display Methods

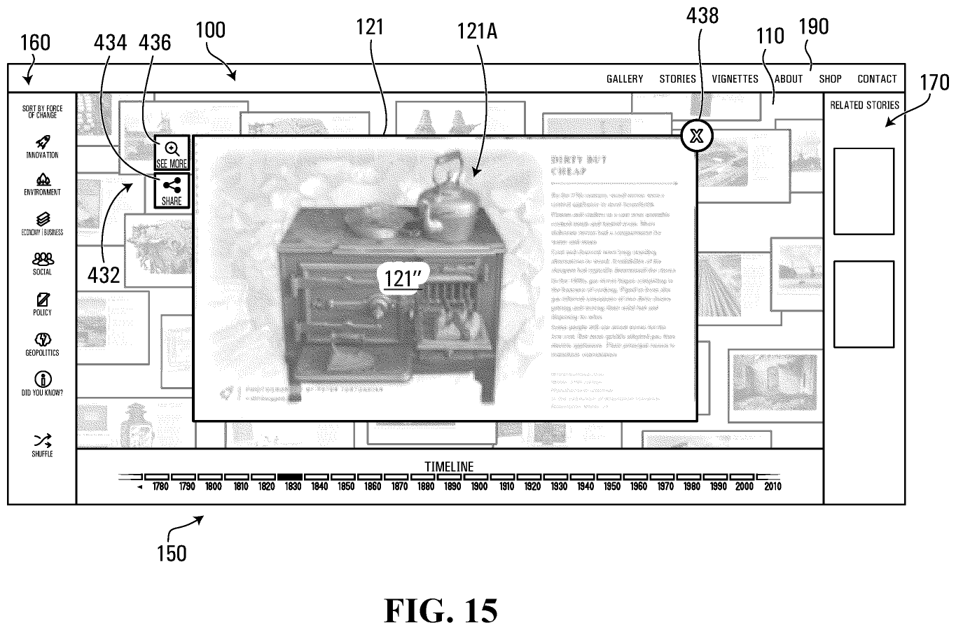

In various embodiments, the vignettes described herein (e.g., vignettes 2, 120) may comprise data structures supporting, in one mode, the display of certain content on a first view or face, and in a second mode, the display of other content on a second view or face. For example, in various embodiments each vignette 120 may comprise a visual representation in the form of a description card with a first view or face (marked “A”) comprising the images and/or or text and a second view or face (marked “B”) comprising additional content. Additional display methods may be performed by the one or more processors to navigate between the first and second views or faces. An example is now described with reference to FIG. 15, which shows a first view or face 121A of vignette 121 of FIGS. 6-10; and FIG. 16, which shows a second view or face 121B of vignette 121 configured to display one or more digital assets associated with the content presented in first view or face 121A.

As shown in FIG. 20, in various embodiments an exemplary display method 400 in keeping with FIG. 15 may comprise: selecting a selected vignette 121 of the plurality of vignettes 120 with selector 102 (a “selecting step 410”); transforming the local area of selected vignette 121 into an expanded local area sized to occupy an enlarged or substantial portion of viewport 110 (a “transforming step 420”); displaying the expanded local area of selected vignette 121 in viewport 110 (a “displaying step 430”); displaying an interface 432 for navigating between first view or face 121A of selected vignette 121 and second view or face 121B of selected vignette 121 (a “displaying step 440”); identifying one or more assets associated with selected vignette 121 (an “identifying step 450”); and/or displaying content associated with the identified assets on second view or face 121B of selected vignette 121 responsive to interface 432 (a “displaying step 460”).

Selecting step 410 of display method 400 may comprise selecting selected vignette 121 with selector 102 by any selection mechanism or technique via an input device, such as a mouse, a touchscreen, a touchpad or the like. Any one of vignettes 120 may be selected in this manner (i.e., any vignette 120 may be the selected vignette).

Transforming step 420 of display method 400 may comprise expanding the local area of selected vignette 121 until it occupies an enlarged or substantial portion of viewport 110, such as, by way of example, more than about 50% of the size of viewport 110. Step 410 also may comprise additional steps for centering the expanded local area in viewport 110.

Displaying step 430 of display method 400 may comprise generating and displaying the expanded local area of selected vignette 121 in viewport 110.

Displaying step 440 of display method 400 may comprise generating interface 432 to include one or more of the following: a sharing interface 434, an access additional content interface 436, and an exit interface 438. Sharing interface 434 may be selected with selector 102 to share selected vignette 121 by any known mechanism or technique (e.g., via social media links). Access additional content interface 436 may comprise a “see more” icon for navigating between first view or face 121A of FIG. 15 and second view or face 121B of FIG. 16 so that the user may have access to additional content associated with selected vignette 121. For example, interface 436 may be displayed in step 440 if there is additional content that is associated with selected vignette 120 and not displayed on first view or face 121A. Exit interface 438 may be selected to terminate display method 400 by returning the user to a state of graphical interface 100 (e.g., the state shown in FIG. 4). As shown in FIG. 15, displaying step 440 also may comprise positioning interface 432 adjacent the expanded local area of selected vignette 121.

Identifying step 450 of display method 400 may be based on data input to vignette input field 93′ for each asset via asset edit portion 85′ of administrative interface 10 (e.g., as shown in FIG. 2J) and/or may be based on data input to vignette edit portion 49 (e.g., as shown in FIG. 2B).

Displaying step 460 of display method 400 may comprise intermediate steps for identifying any content (e.g., any image, audio, and/or video files) associated with each asset via content input field 94 of asset edit portion 85′. Displaying step 460 also may comprise modifying graphical interface 100. As shown in FIG. 16, displaying step 460 may comprise: removing one or more of timeline interface 150, category interface 160, story interface 170 and search interface 180 from graphical interface 100 so as to focus the user on second view or face 121B; identifying a set of relevant vignettes 452 from plurality of vignettes 120; displaying a related vignette interface 454 comprising links to the set of relevant vignettes 452; and displaying an activation button 439 for engaging the content (e.g., a play button in this instance).

The set of related vignettes 452 may be identified in display step 460 based on any data in relational database 1, including any tags 6 and their weighting variables 7. For example, each relevant vignette 452 may have at least one tag 6 in common with selected vignette 121 so that a set of relevancy scores may be calculated therebetween and utilized to select and define an order of set of relevant vignettes 452 in related vignette interface 454. In FIG. 16, for example, interface 454 comprises links to vignettes 123, 126, 131, 133, 136, and 137; each of which has been identified during step 450 as being relevant to selected vignette 121.

Each relevancy score may be calculated as a sum of: a first percentage of a first weighting variable 7 between selected vignette 121 and common tag 6; and a second percentage of a second weighting variable 7 between each potentially reactive vignette 120″ and the common tag 6. The first percentage may be different (e.g., 100%) than the second percentage (e.g., 50%). For example, a visual representation of the calculation may comprise:

[1.0×(WV₁ of S/T₁=10)]+[0.50×(WV₂ of R₁/T₁=6)]=RS of 13

[1.0×(WV₁ of S/T₂=6)]+[0.50×(WV₂ of R₂/T₂=10)]=RS of 11

[1.0×(WV₁ of S/T₃=5)]+[0.50×(WV₂ of R₃/T₃=7)]=RS of 8.5

[1.0×WV₁ of S/T₄=3)]+[0.50×(WV₂ of R₄/T₄=8)]=RS of 7

[1.0×(WV₁ of S/T₅=1)]+[0.50×(WV₂ of R₅/T₅=10)]=RS of 6

In which: “WV” means weighting variable; “S” means selected vignette 121; “Rₓ” means one of a set of potentially relevant vignettes; “Tₓ” means a tag common to selected vignette 121 and each potentially relevant vignette; and “RS” means the relevancy score. In this example, the set of relevant vignettes 452 may be selected based on any grouping of the relevancy scores, including any groupings based on one or more threshold values, like a minimum relevancy score.

Aspects of display method 400 may be performed similarly for other items in database 1. For example, in some embodiments a similar display method may comprise: selecting a selected story 4 with selector 102; identifying content associated with the selected story 4; and displaying an interface (e.g., similar to interface 432) for navigating between content associated with the selected story 4. As a further example, the content may comprise text and/or audio-visual content, and the interface may be configured to navigate therebetween, similar to above.

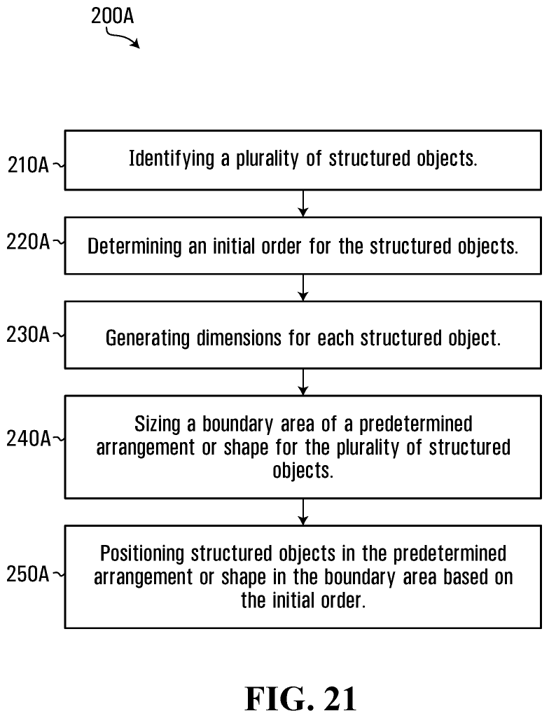

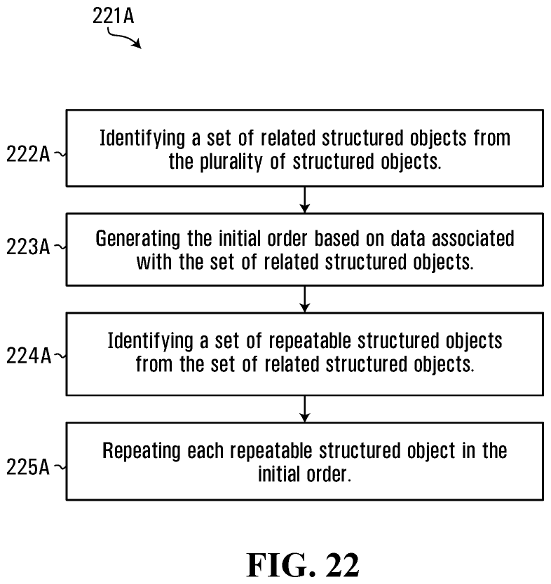

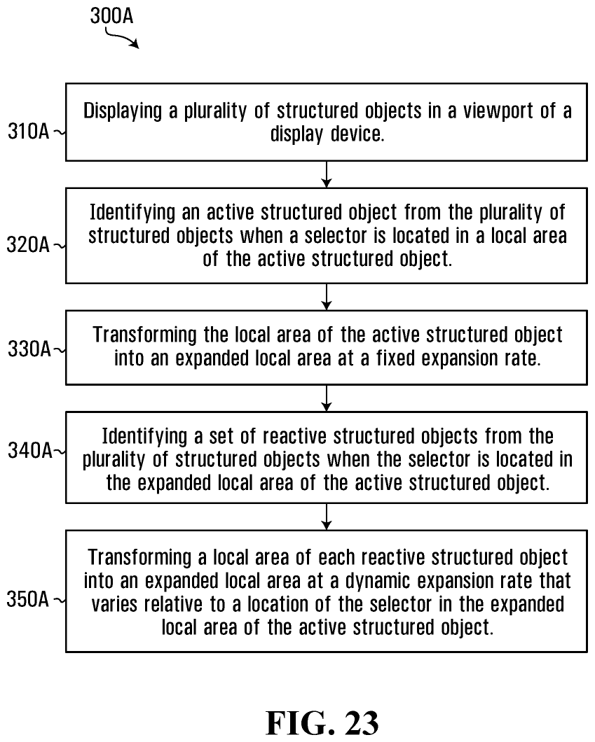

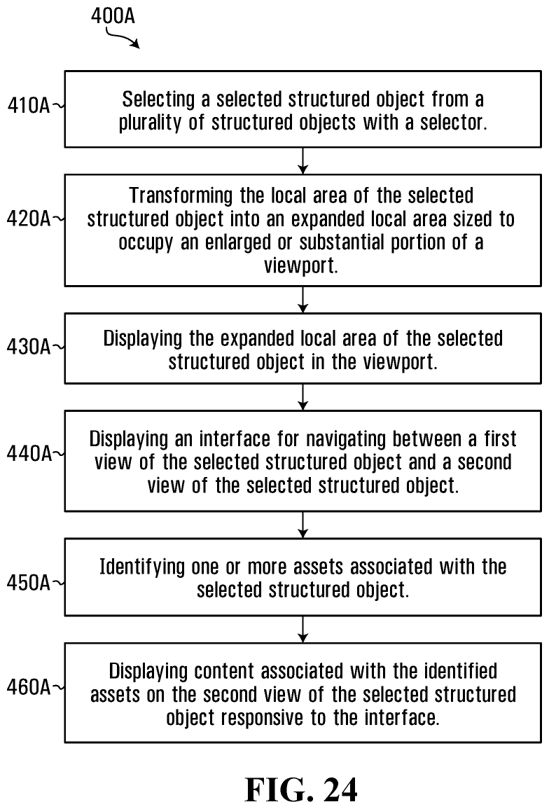

Some aspects of this disclosure are described with reference to vignettes, such as vignettes 2, 120, and the like. Without departing from this disclosure, these aspects also may be described more generically with reference to structured objects, database items, or other computer-implemented means. Examples are now described with reference to: (i) a computer-implemented display method 200A shown in FIG. 21, which is a generic counterpart to display method 220 of FIG. 17; (ii) a computer-implemented ordering method 221A of FIG. 22, which is a generic counterpart to ordering method 221 of FIG. 18; (iii) a computer-implemented navigation method 300A shown in FIG. 23, which is a generic counterpart to navigation method 300 of FIG. 19; and (iv) a computer-implemented display method 400A shown in FIG. 20, which is a generic counterpart to display method 400 of FIG. 24.

As shown in FIG. 21, in various embodiments display method 200A may comprise: (i) identifying a plurality of structured objects (an “identifying step 210A”); (ii) determining an initial order for the plurality of structured objects (a “determining step 220A”); (iii) generating dimensions for each structured object (a “dimensioning step 230A”); (iv) sizing a boundary area of the predetermined arrangement or shape for the plurality of structured objects (a “sizing step 240A”); and/or (v) positioning the plurality of structured objects in the predetermined arrangement or in the boundary area based on the initial order (a “positioning step 250A”). Any aspects of display method 200A of FIG. 21 may be further modified according to any aspects of display method 200 of FIG. 17.

In keeping with above, determining step 220A of display method 200A may comprise ordering process 221A. As shown in FIG. 22, for example, ordering process 221A may comprise: (i) identifying a set of related structured objects from the plurality of structured objects (an “identifying step 222A”); (ii) generating the initial order based on data associated with the set of related structured objects (a “generating step 223A”); (iii) identifying a set of repeatable structured objects from the set of related structured objects (an “identifying step 224A”); and/or (iv) repeating each repeatable structured object in the initial order (a “repeating step 225A”). As before, any aspects of ordering method 221A of FIG. 22 may be further modified according to any aspects of ordering method 221 of FIG. 18.

As shown in FIG. 23, in various embodiments navigation method 300A may comprise: (i) displaying a plurality structured objects in a viewport 110 of a display device (a “displaying step 310A); (ii) identifying an active structured object from the plurality of structured objects when a selector is located in a local area of active structured object (an “identifying step 320A”); (iii) transforming the local area of the active structured object into an expanded local area at a fixed expansion rate (“a transforming step 330A”); (iv) identifying a set of reactive structured objects from the plurality of structured objects when the selector is located in the expanded local area of the active structured object (an “identifying step 340A”); and/or (v) transforming a local area of each reactive structured object into an expanded local area at a dynamic expansion rate that varies relative to a location of the selector in the expanded local area of the active structured object (a “transforming step 350A”). As before, any aspects of navigation method 300A of FIG. 23 may be further modified according to any aspects of navigation method 300 of FIG. 19.

As shown in FIG. 24, in various embodiments display method 400A may comprise: (i) selecting a selected structured object from a plurality of structured objects with a selector (a “selecting step 410A”); (ii) transforming the local area of the selected structured object into an expanded local area sized to occupy an enlarged or substantial portion of a viewport (a “transforming step 420A”); (iii) displaying the expanded local area of the selected structured object in the viewport (a “displaying step 430A”); (iv) displaying an interface (e.g., “see more” icon or access additional content interface 436) for navigating between a first view or face of the selected structured object and a second view or face of the selected structured object (a “displaying step 440A”); (v) identifying one or more assets associated with the selected structured object (an “identifying step 450A”); and/or (vi) displaying content associated with the identified assets on the second view or face of the selected structured object responsive to the interface (a “displaying step 460A”). Once again, any aspects of display method 400A of FIG. 24 may be further modified according to any aspects of display method 400 of FIG. 20.

While principles of the present disclosure are disclosed herein with reference to illustrative aspects of particular applications, the disclosure is not limited thereto. Those having ordinary skill in the art and access to the teachings provided herein will recognize the additional modifications, applications, aspects, and substitution of equivalents may all fall in the scope of the aspects described herein. Accordingly, the present disclosure is not to be considered as limited by the foregoing descriptions.

1-34. (canceled)

35. A computer-implemented method comprising:
displaying a plurality of structured objects in a viewport of a display device;
identifying an active structured object from the plurality of structured objects when a selector is located in a local area of the active structured object;
transforming the local area of the active structured object into a first expanded local area at a fixed expansion rate;
identifying a set of reactive structured objects from the plurality of structured objects when the selector is located in the first expanded local area of the active structured object; and
transforming a local area of each reactive structured object into a second expanded local area at a dynamic expansion rate that varies relative to a horizontal location and a vertical location of the selector in the first expanded local area of the active structured object.

36-39. (canceled)

40. The method of claim 35, wherein:
identifying the set of reactive structured objects comprises applying a geometry-based rule set to the plurality of structured objects;
applying the geometry-based rule set comprises:
defining an identification area relative to the selector; and
identifying the set of reactive structured objects based on whether a local area of each structured object of the plurality of structured objects is proximate to the identification area when the selector is located in the first expanded local area; and
the dynamic expansion rate for each reactive structured object varies relative to the position of the local area of the reactive structured object relative to the identification area so that the local areas of reactive structured objects closer to the first expanded local area are transformed differently from the local areas of the reactive structured objects further away from the first expanded local area.

41. The method of claim 40, wherein the identification area comprises a geometric shape centered on a selection point of the selector.

42. The method of claim 41, wherein the geometric shape is circular.

43. (canceled)

44. The method of claim 35, wherein the variable expansion rate is calculated for each reactive structured object.

45. The method of claim 44, wherein:
the first expanded local area of the active structured object defines a grid; and
the variable expansion rate for each reactive structured object is continuously calculated for each reactive structured object based on a position of the selector in the grid.

46. The method of claim 35, wherein displaying the plurality of structured objects comprises arranging the plurality of structured objects in a predetermined arrangement or shape in the viewport.

47. The method of claim 46, comprising:
identifying a set of repeatable structured objects from the plurality of structured objects; and
repeating each repeatable structured object in the predetermined arrangement or shape.

48. The method of claim 46, wherein the predetermined arrangement or shape comprises a spiral shape.

49. The method of claim 48, wherein the plurality of structured objects are overlapping to minimize a boundary area of the predetermined arrangement or shape.

50. The method of claim 46, comprising moving the predetermined arrangement or shape in the viewport with the selector.

51. The method of claim 50, comprising applying a simulated friction force to a movement of the predetermined arrangement or shape in the viewport.

52. (canceled)

53. The method of claim 35, comprising arranging the plurality of structured objects in the predetermined arrangement or shape based on data associated with each structured object.

54-58. (canceled)

59. The method of claim 35, comprising:
selecting a selected structured object of the plurality of structured objects with the selector;
transforming the local area of the selected structured object into an expanded local area sized to occupy an enlarged portion of the viewport; and
displaying a interface configured, in response to user input, to change display between a first view or face of the selected structured object and a second view or face of the selected structured object.

60. The method of claim 59, comprising:
identifying an asset associated with the selected structured object; and
displaying the asset on the second view or face of the selected structured object.

61-63. (canceled)

64. The method of claim 35, comprising:
identifying one or more stories associated with the active structured object; and
displaying a link to the one or more stories in a portion of the viewport.

65. The method of claim 35, comprising:
receiving search criteria; and
displaying the plurality of structured objects in the viewport based on the search criteria.

66. The method of claim 65, wherein displaying the plurality of structured objects in the viewport based on the search criteria comprises:
identifying a set of relevant structured objects from the plurality of structured objects based on the search criteria;
identifying a set of non-relevant structured objects from the plurality of structured objects based on the search criteria; and
causing each relevant structured object to be emphasized or highlighted in the viewport.

67. The method of claim 66, wherein causing each relevant structured object to be emphasized or highlighted in the viewport comprises:
displaying the set of relevant structured objects in a generally central portion of the viewport; and
displaying the set of non-relevant structured objects in a de-emphasized manner in the viewport.

68. The method of claim 35, wherein the plurality of structured objects is a plurality of vignettes.
